(19) United States
(12) Patent Application Publication
(10) Pub. No.: US 2025/0274818 A1
(43) Pub. Date: Aug. 28, 2025

(54) SECURITY ASPECTS FOR LAYER 1 OR LAYER 2 TRIGGERED MOBILITY

(71) Applicant: QUALCOMM Incorporated, San Diego, CA (US)

(72) Inventors: Naeem AKL, Bridgewater, NJ (US); Punyaslok PURKAYASTHA, San Diego, CA (US); Soo Bum LEE, San Diego, CA (US); Prasad Reddy KADIRI, San Diego, CA (US)

(21) Appl. No.: 18/584,884

(22) Filed: Feb. 22, 2024

(51) Int. Cl. H04W 36/00

(52) U.S. Cl. CPC H04W 36/0038

(57) ABSTRACT

Some wireless communication systems perform handover procedures to transfer user equipment (UE) communications between network entities. In some approaches, handover procedures may be performed via layer 3 (L3) signaling (e.g., L3 mobility). Layer 1 (L1) or Layer 2 (L2) triggered mobility (LTM) may allow handovers to be triggered via L1 or L2 signaling. Some of the techniques described herein may be utilized to handle key derivations when a UE is configured with candidate LTM cells of different network entities. For example, security keys may be updated with one or more inter-network entity LTM handovers after an initial handover. From the UE perspective, the UE may receive a configuration of LTM candidates once, but may perform one or more LTM executions using the configuration of LTM candidates. After the initial LTM procedure for the initial handover, the UE may receive an independent security configuration update for a subsequent LTM execution.

### FIELD OF TECHNOLOGY

The following relates to wireless communications, including security aspects for layer 1 or layer 2 triggered mobility.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

Some wireless communication systems perform handover procedures to transfer user equipment (UE) communications between network entities. In some approaches, handover procedures may be performed via layer 3 (L3) signaling (e.g., L3 mobility). For instance, radio resource control (RRC) signaling may be utilized to manage handovers (e.g., security aspects of handovers). Layer 1 (L1) or Layer 2 (L2) triggered mobility (LTM) may allow handovers to be triggered via L1 or L2 signaling.

Some of the techniques described herein may be utilized to handle key derivations when a UE is configured with candidate LTM cells of different network entities (e.g., gNodeBs (gNBs)). For example, security keys may be updated with one or more inter-gNB LTM handovers after an initial handover.

From the UE perspective, the UE may receive a configuration of LTM candidates once, but may perform one or more LTM executions using the configuration of LTM candidates (e.g., candidate network entities or candidate cells, among other examples). For initial configuration, the UE may receive a security configuration with the configuration of LTM candidates, where the security configuration may be utilized to secure communication with a target cell for an initial handover via an initial LTM procedure. After the initial LTM procedure for the initial handover, the UE may receive an independent security configuration update (e.g., next hop chaining count (NCC) value) for a subsequent LTM execution. For example, the LTM configuration may occur once, but a key update may recur with one or more subsequent inter-gNB LTM executions. The key update may be provided from the same or a different network entity (e.g., gNB) that configures the LTM candidates on the UE, because a serving network entity may change with a subsequent LTM procedure. In some aspects, the UE may defer the application of the latest received security material until a next LTM execution is triggered.

One or more approaches may be utilized from the network perspective. In a first approach, a source network entity may provide security material for a next LTM execution to a target network entity using an LTM triggering notification message, with or after triggering an LTM procedure on the UE. In a second approach, a source network entity may provide security material for a next LTM execution to one or more candidate network entities (e.g., one or more network entities providing potential target cells) prior to triggering an LTM procedure on the UE. Security material may be invalidated at one or more candidate network entities other than the target network entity after the LTM execution completes. In some cases, a target network entity may perform a path switch procedure with an access and mobility management function (AMF) entity.

Some examples of the techniques described herein may enable security updates for inter-network entity handovers via LTM procedures. For instance, a configuration of candidate network entities may be reused after an initial handover for a subsequent handover, while updated security material (e.g., a new NCC value) may be utilized for the subsequent handover. In some approaches, the security material may be independently updated (via an RRC message, for example) without updating the configuration of candidate network entities. Independently updating the security material may maintain or enhance communication security while reducing control signaling for multiple handovers.

A method by a UE is described. The method may include receiving first information indicating at least one LTM candidate configuration associated with a second cell provided by a second network entity, where the first information is retained for a second handover with an independently updated security configuration subsequent to a first handover that is based on the at least one LTM candidate configuration, receiving second information from a first network entity, the second information indicating a first security configuration for securing UE communication, performing a first LTM procedure for the first handover or the second handover of the UE to the second cell based on the first information, and transmitting a signal to the second network entity based on the second information indicating the first security configuration.

A UE is described. The UE may include one or more memories storing processor executable code, and one or more processors coupled with the one or more memories. The one or more processors may individually or collectively be operable to execute the code to cause the UE to receive first information indicating at least one LTM candidate configuration associated with a second cell provided by a second network entity, where the first information is retained for a second handover with an independently updated security configuration subsequent to a first handover that is based on the at least one LTM candidate configuration, receive second information from a first network entity, the second information indicating a first security configuration for securing UE communication, perform a first LTM procedure for the first handover or the second handover of the UE to the second cell based on the first information, and transmit a signal to the second network entity based on the second information indicating the first security configuration.

Another UE is described. The UE may include means for receiving first information indicating at least one LTM candidate configuration associated with a second cell provided by a second network entity, where the first information is retained for a second handover with an independently updated security configuration subsequent to a first handover that is based on the at least one LTM candidate configuration, means for receiving second information from a first network entity, the second information indicating a first security configuration for securing UE communication, means for performing a first LTM procedure for the first handover or the second handover of the UE to the second cell based on the first information, and means for transmitting a signal to the second network entity based on the second information indicating the first security configuration.

A non-transitory computer-readable medium storing code is described. The code may include instructions executable by one or more processors to receive first information indicating at least one LTM candidate configuration associated with a second cell provided by a second network entity, where the first information is retained for a second handover with an independently updated security configuration subsequent to a first handover that is based on the at least one LTM candidate configuration, receive second information from a first network entity, the second information indicating a first security configuration for securing UE communication, perform a first LTM procedure for the first handover or the second handover of the UE to the second cell based on the first information, and transmit a signal to the second network entity based on the second information indicating the first security configuration.

In some examples of the method, UEs, and non-transitory computer-readable medium described herein, the first information indicating the at least one LTM candidate configuration and the second information indicating the first security configuration may be received in a same message.

In some examples of the method, UEs, and non-transitory computer-readable medium described herein, the first information indicating the at least one LTM candidate configuration includes an LTM candidate configuration associated with a third cell and the first LTM procedure is for the first handover, and the method, UEs, and non-transitory computer-readable medium described herein may further include operations, features, means, or instructions for receiving third information from the second network entity subsequent to the first handover, the third information indicating a second security configuration for securing UE communication, receiving a second indication to trigger a second LTM procedure of the UE to the third cell, performing the second LTM procedure for the second handover of the UE to the third cell based on the first information, and transmitting a second signal via the third cell based on the third information indicating the second security configuration.

In some examples of the method, UEs, and non-transitory computer-readable medium described herein, the first information indicating the at least one LTM candidate configuration and the second information indicating the first security configuration may be received from different network entities.

In some examples of the method, UEs, and non-transitory computer-readable medium described herein, the method, source network entities, and non-transitory computer-readable medium described herein may further include operations, features, means, or instructions for performing a second LTM procedure for the first handover of the UE to a first cell provided by the first network entity prior to receiving the second information.

In some examples of the method, UEs, and non-transitory computer-readable medium described herein, the first security configuration includes a NCC value.

In some examples of the method, UEs, and non-transitory computer-readable medium described herein, the second information includes an indication that the first security configuration may be for an LTM procedure between network entities, an LTM procedure to the second network entity, an LTM procedure to a network entity included in a set of network entities including the second network entity, an LTM procedure to a first cell provided by the first network entity, an LTM procedure to a cell included in a set of cells including a first cell provided by the first network entity, or any combination thereof.

In some examples of the method, UEs, and non-transitory computer-readable medium described herein, the first information and the second information may be received from one network entity.

A method by a source network entity is described. The method may include outputting second information to a UE, the second information indicating a first security configuration for securing UE communication and outputting a first indication from the source network entity to trigger a first LTM procedure for a first handover or a second handover of the UE to a second cell provided by a second network entity, where the second cell is associated with at least one LTM candidate configuration for the second handover with an independently updated security configuration subsequent to the first handover that is based on the at least one LTM candidate configuration.

A source network entity is described. The source network entity may include one or more memories storing processor executable code, and one or more processors coupled with the one or more memories. The one or more processors may individually or collectively be operable to execute the code to cause the source network entity to output second information to a UE, the second information indicating a first security configuration for securing UE communication and output a first indication from the source network entity to trigger a first LTM procedure for a first handover or a second handover of the UE to a second cell provided by a second network entity, where the second cell is associated with at least one LTM candidate configuration for the second handover with an independently updated security configuration subsequent to the first handover that is based on the at least one LTM candidate configuration.

Another source network entity is described. The source network entity may include means for outputting second information to a UE, the second information indicating a first security configuration for securing UE communication and means for outputting a first indication from the source network entity to trigger a first LTM procedure for a first handover or a second handover of the UE to a second cell provided by a second network entity, where the second cell is associated with at least one LTM candidate configuration for the second handover with an independently updated security configuration subsequent to the first handover that is based on the at least one LTM candidate configuration.

A non-transitory computer-readable medium storing code is described. The code may include instructions executable by one or more processors to output second information to a UE, the second information indicating a first security configuration for securing UE communication and output a first indication from a source network entity to trigger a first LTM procedure for a first handover or a second handover of the UE to a second cell provided by a second network entity, where the second cell is associated with at least one LTM candidate configuration for the second handover with an independently updated security configuration subsequent to the first handover that is based on the at least one LTM candidate configuration.

In some examples of the method, source network entities, and non-transitory computer-readable medium described herein, the first security configuration includes a NCC value.

In some examples of the method, source network entities, and non-transitory computer-readable medium described herein, the second information includes an indication that the first security configuration may be for an LTM procedure between network entities, an LTM procedure to the second network entity, an LTM procedure to a network entity included in a set of network entities including the second network entity, an LTM procedure to a first cell provided by the source network entity, an LTM procedure to a cell included in a set of cells including a first cell provided by the source network entity, or any combination thereof.

Some examples of the method, source network entities, and non-transitory computer-readable medium described herein may further include operations, features, means, or instructions for outputting first information to the UE, the first information indicating the at least one LTM candidate configuration associated with the second cell provided by the second network entity.

Some examples of the method, source network entities, and non-transitory computer-readable medium described herein may further include operations, features, means, or instructions for outputting an indication of the first security configuration to a network entity that provides a cell that may be associated with the at least one LTM candidate configuration for the UE.

In some examples of the method, source network entities, and non-transitory computer-readable medium described herein, the network entity may be the second network entity and the cell may be a target cell for the first LTM procedure for the first handover.

In some examples of the method, source network entities, and non-transitory computer-readable medium described herein, the network entity may be a third network entity separate from the second network entity and the cell may be a third cell separate from a target cell for the first LTM procedure for the first handover.

In some examples of the method, source network entities, and non-transitory computer-readable medium described herein, the indication further indicates a NCC value and a key value associated with the cell provided by the network entity.

In some examples of the method, source network entities, and non-transitory computer-readable medium described herein, the indication may be outputted concurrently with the first LTM procedure or subsequent to the first LTM procedure.

In some examples of the method, source network entities, and non-transitory computer-readable medium described herein, the indication may be outputted prior to the first LTM procedure or prior to outputting the second information to the UE.

Some examples of the method, source network entities, and non-transitory computer-readable medium described herein may further include operations, features, means, or instructions for outputting a second indication to the network entity to invalidate the indication of the first security configuration based on a performance of an LTM procedure of the UE to a target cell separate from the cell that may be associated with the at least one LTM candidate configuration for the UE.

Some examples of the method, source network entities, and non-transitory computer-readable medium described herein may further include operations, features, means, or instructions for obtaining at least part of the first security configuration from an AMF entity associated with the UE for outputting the second information to the UE, the first security configuration including a NCC value or an indication for the source network entity to utilize a fresh key.

Some examples of the method, source network entities, and non-transitory computer-readable medium described herein may further include operations, features, means, or instructions for outputting an NCC value of zero to the UE in response to the indication for the source network entity to utilize the fresh key.

In some examples of the method, source network entities, and non-transitory computer-readable medium described herein, the source network entity may include a central unit (CU) and a distributed unit (DU), and the CU may output the second information to the UE via the DU, the DU may output the first indication to trigger the first LTM procedure to the UE, the DU may output an indication of triggering the first LTM procedure to the CU, and the CU may output an indication of the first security configuration to the second network entity, a third network entity, or a combination thereof.

In some examples of the method, source network entities, and non-transitory computer-readable medium described herein, the second network entity may be the source network entity.

A method by a target network entity is described. The method may include obtaining, from a source network entity, an indication of triggering a first LTM procedure for a first handover or a second handover of a UE to a target cell provided by the target network entity, where the target cell is associated with at least one LTM candidate configuration for the second handover with an independently updated security configuration subsequent to the first handover that is based on the at least one LTM candidate configuration, obtaining an indication of a first security configuration for securing UE communication with the target network entity, obtaining a message from the UE indicating a completion of the LTM procedure to the target cell, and communicating with the UE based on the message and the indication.

A target network entity is described. The target network entity may include one or more memories storing processor executable code, and one or more processors coupled with the one or more memories. The one or more processors may individually or collectively be operable to execute the code to cause the target network entity to obtain, from a source network entity, an indication of triggering a first LTM procedure for a first handover or a second handover of a UE to a target cell provided by the target network entity, where the target cell is associated with at least one LTM candidate configuration for the second handover with an independently updated security configuration subsequent to the first handover that is based on the at least one LTM candidate configuration, obtain an indication of a first security configuration for securing UE communication with the target network entity, obtain a message from the UE indicating a completion of the LTM procedure to the target cell, and communicate with the UE based on the message and the indication.

Another target network entity is described. The target network entity may include means for obtaining, from a source network entity, an indication of triggering a first LTM procedure for a first handover or a second handover of a UE to a target cell provided by the target network entity, where the target cell is associated with at least one LTM candidate configuration for the second handover with an independently updated security configuration subsequent to the first handover that is based on the at least one LTM candidate configuration, means for obtaining an indication of a first security configuration for securing UE communication with the target network entity, means for obtaining a message from the UE indicating a completion of the LTM procedure to the target cell, and means for communicating with the UE based on the message and the indication.

A non-transitory computer-readable medium storing code is described. The code may include instructions executable by one or more processors to obtain, from a source network entity, an indication of triggering a first LTM procedure for a first handover or a second handover of a UE to a target cell provided by the target network entity, where the target cell is associated with at least one LTM candidate configuration for the second handover with an independently updated security configuration subsequent to the first handover that is based on the at least one LTM candidate configuration, obtain an indication of a first security configuration for securing UE communication with the target network entity, obtain a message from the UE indicating a completion of the LTM procedure to the target cell, and communicate with the UE based on the message and the indication.

In some examples of the method, target network entities, and non-transitory computer-readable medium described herein, the first security configuration includes a next hop (NH) value and a NCC value.

In some examples of the method, target network entities, and non-transitory computer-readable medium described herein, the message includes a radio resource control (RRC) reconfiguration complete message.

Some examples of the method, target network entities, and non-transitory computer-readable medium described herein may further include operations, features, means, or instructions for buffering the message to process the message subsequent to obtaining the indication of the first security configuration.

Some examples of the method, target network entities, and non-transitory computer-readable medium described herein may further include operations, features, means, or instructions for outputting a path switch request to an AMF entity based on the message and obtaining an acknowledgment of the path switch request with an updated NH value and an updated NCC value.

### BRIEF DESCRIPTION OF THE DRAWINGS

FIG. 1 shows an example of a wireless communications system that supports security aspects for layer 1 or layer 2 triggered mobility (LTM) in accordance with one or more aspects of the present disclosure.

FIG. 2 shows an example of a network architecture that supports security aspects for LTM in accordance with one or more aspects of the present disclosure.

FIG. 3 shows an example of a wireless communications system that supports security aspects for LTM in accordance with one or more aspects of the present disclosure.

FIG. 4 shows an example of a wireless communications system that supports security aspects for LTM in accordance with one or more aspects of the present disclosure.

FIG. 5 shows an example of a wireless communications system that supports security aspects for LTM in accordance with one or more aspects of the present disclosure.

FIG. 6 shows an example of a process flow that supports security aspects for LTM in accordance with one or more aspects of the present disclosure.

FIGS. 7 and 8 show block diagrams of devices that support security aspects for LTM in accordance with one or more aspects of the present disclosure.

FIG. 9 shows a block diagram of a communications manager that supports security aspects for LTM in accordance with one or more aspects of the present disclosure.

FIG. 10 shows a diagram of a system including a device that supports security aspects for LTM in accordance with one or more aspects of the present disclosure.

FIGS. 11 and 12 show block diagrams of devices that support security aspects for LTM in accordance with one or more aspects of the present disclosure.

FIG. 13 shows a block diagram of a communications manager that supports security aspects for LTM in accordance with one or more aspects of the present disclosure.

FIG. 14 shows a diagram of a system including a device that supports security aspects for LTM in accordance with one or more aspects of the present disclosure.

FIGS. 15 and 16 show block diagrams of devices that support security aspects for LTM in accordance with one or more aspects of the present disclosure.

FIG. 17 shows a block diagram of a communications manager that supports security aspects for LTM in accordance with one or more aspects of the present disclosure.

FIG. 18 shows a diagram of a system including a device that supports security aspects for LTM in accordance with one or more aspects of the present disclosure.

FIGS. 19 through 24 show flowcharts illustrating methods that support security aspects for LTM in accordance with one or more aspects of the present disclosure.

### DETAILED DESCRIPTION

Some wireless communication systems perform handover procedures to transfer UE communications between network entities. In some approaches, handover procedures may be performed via layer 3 (L3) signaling (e.g., L3 mobility). For instance, radio resource control (RRC) signaling may be utilized to manage handovers (e.g., security aspects of handovers). Layer 1 (L1) or Layer 2 (L2) triggered mobility (LTM) may allow handovers to be triggered via L1 or L2 signaling.

In some approaches, only intra-gNodeB (gNB) LTM may be supported, where security updates during LTM may be unsupported. Without security updates for inter-gNB LTM, communication security may be compromised. For example, after an initial handover using an LTM procedure, a UE may retain LTM candidate configurations for one or more subsequent LTM procedures. However, without L3 signaling (e.g., without a subsequent L3 mobility procedure) for each subsequent LTM procedure, there is no intermediate handover command that indicates to the UE which next hop chaining count (NCC) value to use for key derivation as the UE attaches to the subsequent target network entities 105 (e.g., gNBs). Accordingly, new procedures for security updates for inter-gNB LTM may be utilized to avoid comprising security for one or more subsequent LTM handovers.

Some of the techniques described herein may be utilized to handle key derivations when a UE is configured with candidate LTM cells of different network entities (e.g., gNBs). For example, security keys may be updated with one or more inter-gNB LTM handovers after an initial handover.

From the UE perspective, the UE may receive a configuration of LTM candidates once, but may perform one or more LTM executions using the configuration of LTM candidates (e.g., candidate network entities or candidate cells, among other examples). For initial configuration, the UE may receive a security configuration with the configuration of LTM candidates, where the security configuration may be utilized to secure communication with a target cell for an initial handover via an initial LTM procedure. After the initial LTM procedure for the initial handover, the UE may receive an independent security configuration update (e.g., NCC value) for a subsequent LTM execution. For example, the LTM configuration may occur once, but a key update may recur with one or more subsequent inter-gNB LTM executions. The key update may be provided from the same or a different network entity (e.g., gNB) that configures the LTM candidates on the UE, because a serving network entity may change with a subsequent LTM procedure. In some aspects, the UE may defer the application of the latest received security material until a next LTM execution is triggered.

One or more approaches may be utilized from the network perspective. In a first approach, a source network entity may provide security material for a next LTM execution to a target network entity using an LTM triggering notification message, with or after triggering an LTM procedure on the UE. In a second approach, a source network entity may provide security material for a next LTM execution to one or more candidate network entities (e.g., one or more network entities providing potential target cells) prior to triggering an LTM procedure on the UE. Security material may be invalidated at one or more candidate network entities other than the target network entity after the LTM execution completes. In some cases, a target network entity may perform a path switch procedure with an access and mobility management function (AMF) entity.

Some examples of the techniques described herein may enable security updates for inter-network entity handovers via LTM procedures. For instance, a configuration of candidate network entities may be reused after an initial handover for a subsequent handover, while updated security material (e.g., a new NCC value) may be utilized for the subsequent handover. In some approaches, the security material may be independently updated (via an RRC message, for example) without updating the configuration of candidate network entities. Independently updating the security material may maintain or enhance communication security while reducing control signaling for multiple handovers.

Aspects of the disclosure are initially described in the context of wireless communications systems. Aspects of the disclosure are additionally described in the context of a process flow diagram. Aspects of the disclosure are further illustrated by and described with reference to apparatus diagrams, system diagrams, and flowcharts that relate to security aspects for LTM.

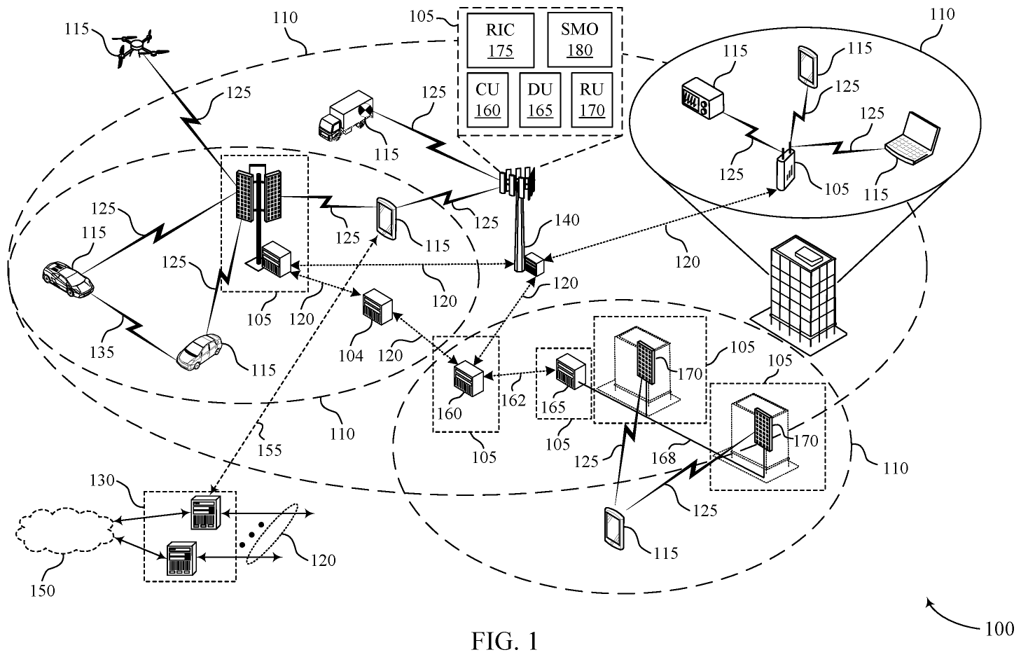

FIG. 1 shows an example of a wireless communications system 100 that supports security aspects for LTM in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., L3, L2) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as L1 (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an AMF) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communication systems perform handover procedures to transfer UE 115 communications between network entities 105. In some approaches, handover procedures may be performed via L3 signaling (e.g., L3 mobility). For instance, RRC signaling may be utilized to manage handovers (e.g., security aspects of handovers). LTM may allow handovers to be triggered via L1 or L2 signaling.

As used herein, the terms “key,” “security key,” or variations thereof may refer to one or more cryptographic keys utilized for communication security (e.g., encryption, decryption, verification, signing, among other examples). For instance, a UE 115 may utilize a key to communicate security with a network entity 105.

A first example of key derivation from the perspective of a UE 115 during a mobility procedure is given as follows. A UE 115 may use a key associated with the first network entity with NCC=5. A UE may receive a handover command, including NCC=5, from a first network entity. The UE 115 may perform horizontal key derivation and perform the handover to a second network entity. As used herein, the term “horizontal key derivation” may indicate a key derivation that is performed without the involvement of one or more core network entities (e.g., AMF entity). For instance, a horizontal key derivation may not involve the generation of a fresh key by an AMF entity. As used herein, a “fresh key” may be a key that is newly generated (by the AMF entity, for example). The UE 115 may use the key associated with the second network entity with NCC=5. The UE 115 may receive a subsequent handover command including NCC=6. The UE 115 may perform vertical key derivation and perform the handover to a third network entity. As used herein, the term “vertical key derivation” may indicate a key derivation that is performed with the involvement of one or more core network entities (e.g., AMF entity). For example, an AMF entity may generate a fresh key and provide the fresh key to a network entity 105, which may relay the fresh key to another network entity 105 for handover. After the handover, the UE 115 may utilize the key associated with the third network entity with NCC=6.

A second example of key derivation from the network perspective during a mobility procedure is given as follows. The second example may correspond to the first example, where the second example provides more detail from the network perspective. A first network entity 105 may not have a fresh key from the AMF, and may currently use a key associated with the first network entity with NCC=5. The first network entity 105 may perform horizontal key derivation and may send a key associated with a second network entity with NCC=5 to the second network entity. The AMF may generate a fresh key with NCC=6, and may send the fresh key to the second network entity 105. The second network entity 105 may perform vertical key derivation may and send a key associated with a third network entity 105 with NCC=6 to the third network entity. The third network entity may use the key associated with the third network entity with NCC=6.

In some approaches, only intra-gNB LTM may be supported, where security updates during LTM may be unsupported. Without security updates for inter-gNB LTM, communication security may be compromised. For example, after an initial handover using an LTM procedure, a UE 115 may retain LTM candidate configurations for one or more subsequent LTM procedures. However, without L3 signaling (e.g., without a subsequent L3 mobility procedure) for each subsequent LTM procedure, there is no intermediate handover command that indicates to the UE 115 which NCC value to use for key derivation as the UE 115 attaches to the subsequent target network entities 105 (e.g., gNBs). Accordingly, new procedures for security updates for inter-gNB LTM may be utilized to avoid comprising security for one or more subsequent LTM handovers.

Some of the techniques described herein may be utilized to handle key derivations when a UE 115 is configured with candidate LTM cells of different network entities (e.g., gNBs). For example, security keys may be updated with one or more inter-gNB LTM handovers after an initial handover.

From the UE 115 perspective, the UE 115 may receive a configuration of LTM candidates once, but may perform one or more LTM executions using the configuration of LTM candidates (e.g., candidate network entities or candidate cells, among other examples). For initial configuration, the UE 115 may receive a security configuration with the configuration of LTM candidates, where the security configuration may be utilized to secure communication with a target cell for an initial handover via an initial LTM procedure. After the initial LTM procedure for the initial handover, the UE 115 may receive an independent security configuration update (e.g., NCC value) for a subsequent LTM execution. For example, the LTM configuration may occur once, but a key update may recur with one or more subsequent inter-gNB LTM executions. The key update may be provided from the same or a different network entity 105 (e.g., gNB) that configures the LTM candidates on the UE 115, because a serving network entity 105 may change with a subsequent LTM procedure. In some aspects, the UE 115 may defer the application of the latest received security material until a next LTM execution is triggered.

One or more approaches may be utilized from the network perspective. In a first approach, a source network entity 105 may provide security material for a next LTM execution to a target network entity 105 using an LTM triggering notification message, with or after triggering an LTM procedure on the UE 115. In a second approach, a source network entity 105 may provide security material for a next LTM execution to one or more candidate network entities (e.g., one or more network entities providing potential target cells) prior to triggering an LTM procedure on the UE 115. Security material may be invalidated at one or more candidate network entities other than the target network entity 105 after the LTM execution completes. In some cases, a target network entity 105 may perform a path switch procedure with an AMF entity.

Some examples of the techniques described herein may enable security updates for inter-network entity 105 handovers via LTM procedures. For instance, a configuration of candidate network entities may be reused after an initial handover for a subsequent handover, while updated security material (e.g., a new NCC value) may be utilized for the subsequent handover. In some approaches, the security material may be independently updated (via an RRC message, for example) without updating the configuration of candidate network entities. Independently updating the security material may maintain or enhance communication security while reducing control signaling for multiple handovers.

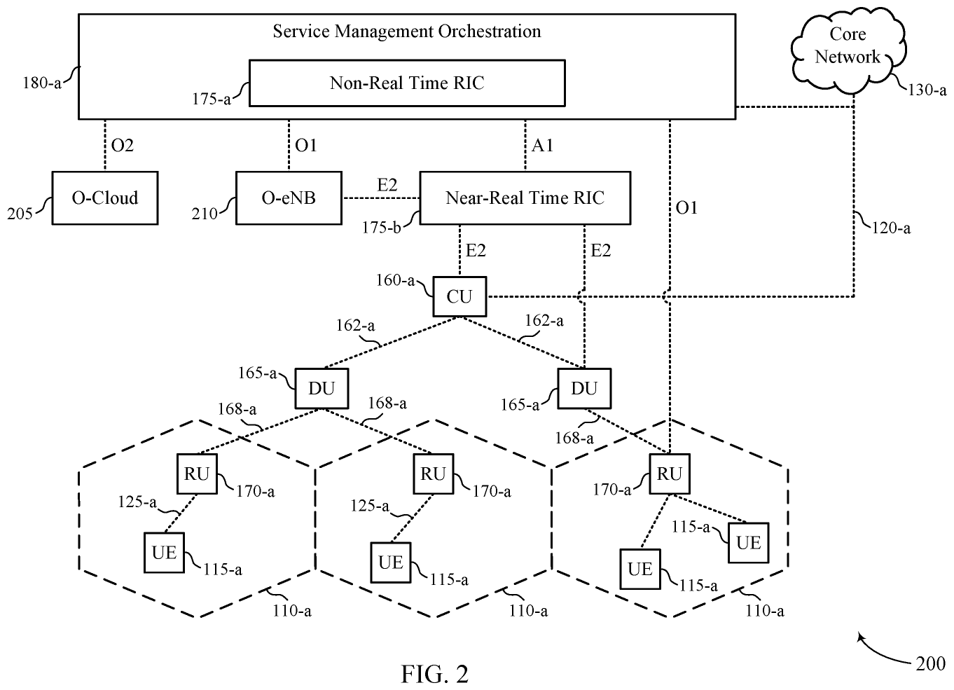

FIG. 2 shows an example of a network architecture 200 (e.g., a disaggregated base station architecture, a disaggregated RAN architecture) that supports security aspects for LTM in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., AI policies).

Some examples of the techniques described herein may be implemented in a CU 160-a, a DU 165-a, an RU 170-a, a UE 115-a, or another entity. For instance, a CU 160-a or a DU 165-a may manage security information (e.g., NH value, NCC value, key value, among other examples) updates. For instance, a CU 160-a or a DU 165-a may provide independently updated security information as described with reference to one or more of FIG. 1, or 3-24. Additionally, or alternatively, a UE 115-a may perform one or more LTM procedures utilizing independently updated security information as described with reference to one or more of FIG. 1, or 3-24.

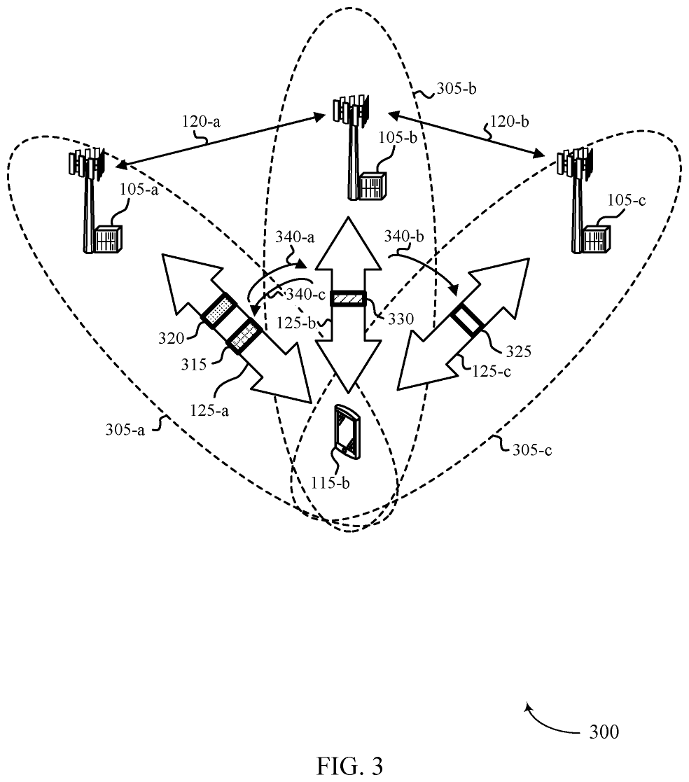

FIG. 3 shows an example of a wireless communications system 300 that supports security aspects for LTM in accordance with one or more aspects of the present disclosure. The wireless communications system 300 may implement aspects of or may be implemented by aspects of the wireless communications system 100 or of the network architecture 200. For example, the wireless communications system 300 includes a UE 115-b, which may be an example of a UE 115 described with respect to FIG. 1 or a UE 115-a described with respect to FIG. 2. The wireless communications system 300 also includes a network entity 105-a, a network entity 105-b, and a network entity 105-c, which may be examples of a network entity 105 as described with respect to FIG. 1.

The UE 115-b may communicate with the network entity 105-a, the network entity 105-b, or the network entity 105-c using respective communication links. For example, the network entity 105-a may provide a cell 305-a for the UE 115-b, the network entity 105-b may provide a cell 305-b, and the network entity 105-c may provide a cell 305-c for communication. While three cells 305-a, 305-b, 305-c are shown in the example of FIG. 3, a different quantity of cells (e.g., serving, candidate, or target cells) may be utilized in some examples. While the cells 305-a, 305-b, 305-c are illustrated as overlapping in FIG. 3, two or more of the cells 305-a, 305-b, 305-c may overlap or may not overlap or the UE 115-b may move into or out of one or more of the cells 305-a, 305-b, 305-c over time.

As used herein, a “cell” may refer to a serving cell, a candidate cell, or a target cell. A serving cell may be a cell that is currently providing a communication resource to a UE (e.g., UE 115-b).

A candidate cell may be a cell that is a candidate for communication with a UE (e.g., UE 115-b). For example, a candidate cell may be a cell that may provide one or more communication resources to a UE (e.g., UE 115-b). A candidate cell may be evaluated by a UE (e.g., the UE 115-b) or a network entity (e.g., the network entity 105-a, network entity 105-b, or network entity 105-c) for handover or cell switching of the UE.

A target cell may be a cell (e.g., a candidate cell) that is selected for communication with a UE (e.g., UE 115-b). A target cell may be a candidate cell that has been selected for communication with a UE. In some examples, one or more candidate cells may be LTM candidate cells (which may be serving cells or non-serving cells), may be a single serving cell, or may be multiple serving cells.

The UE 115-b may establish one or more communication links with one or more of the network entities 105-a, 105-b, 105-c. In some examples, a communication link may be an example of an NR or LTE link between the UE 115-b and a network entity 105-a, network entity 105-b, or network entity 105-c. The communication link may include bi-directional links that enable both uplink and downlink communications. For example, the UE 115-b may transmit uplink signals (e.g., uplink transmissions), such as uplink control signals or uplink data signals, to one or more of network entity 105-a, network entity 105-b, or network entity 105-c. One or more of the network entity 105-a, the network entity 105-b, or the network entity 105-c may transmit downlink signals (e.g., downlink transmissions), such as downlink control signals or downlink data signals, to the UE 115-b using a communication link. In the example of FIG. 3, a first communication link 125-a between the network entity 105-a and the UE 115-b is shown. A second communication link 125-b between the network entity 105-b and the UE 115-b is also shown. A third communication link 125-c between the network entity 105-c and the UE 115-b is also shown. The communication links 125-a, 125-b, 125-c may operate in separate time frames, in overlapping time frames, or may operate concurrently.

The example of FIG. 3 illustrates an example of a first handover 340-a and a subsequent handover (e.g., handover 340-b or handover 340-c). In some approaches, the first handover 340-a and the subsequent handover may be performed via LTM procedures. In some examples, an LTM procedure may be referred to as an LTM cell switch. In an LTM procedure, a handover may be triggered via L1 or L2 signaling from a network entity (e.g., the network entity 105-a or the network entity 105-b). For example, a subsequent handover may be triggered via a media access control (MAC) control element (CE) message (without performing an RRC reconfiguration, for instance). Additionally, or alternatively, a handover may be triggered by a UE 115-b via a conditional LTM procedure. In the conditional LTM procedure, the UE 115-b may perform handover by detaching from a source network entity and accessing a target network entity in response to the satisfaction of one or more handover conditions (e.g., a threshold signal measurement, a decline in signal quality from a source network entity, among other examples). In some examples, ordinal terms (e.g., first, second, third) may not indicate an order or correspondence. In some examples, ordinal terms may indicate an order or correspondence.

The network entity 105-a may output first information 315 indicating at least one LTM candidate configuration associated with one or more cells (e.g., the cell 305-a, the cell 305-b, or the cell 305-c) provided by one or more network entities (e.g., the network entity 105-a, network entity 105-b, or network entity 105-c). The UE 115-b may receive the first information 315. An LTM candidate configuration may be information indicating one or more cells as candidate cells or one or more network entities as candidate network entities for handover. For instance, the network entity 105-a may initially be a serving network entity (that provides the cell 305-a as a serving cell) and may provide the first information 315, which may indicate that one or more of the cell 305-a, the cell 305-b, and the cell 305-c are candidate cells. One or more of the cell 305-a, cell 305-b, or cell 305-c may be associated with at least one LTM candidate configuration. In some examples, an LTM candidate configuration may include one or more parameters (e.g., cell identification information, band information, timing information, or beam information, among other examples) for communicating via one or more cells.

In some examples, the first information 315 may be signaled to the UE 115-b via an RRC message (e.g., RRCReconfiguration message). To set up LTM procedures, for instance, the UE 115-b may send a MeasurementReport message to the network entity 105-a. The network entity 105-a may determine to utilize an LTM procedure and may initiate LTM candidate preparation. For example, the network entity 105-a may transmit an RRCReconfiguration message to the UE 115-b indicating the LTM candidate configuration of one or multiple LTM candidate cells (e.g., the cell 305-a, cell 305-b, and cell 305-c). In some approaches, the UE 115-b may store the LTM candidate configuration of one or more candidate cells, and may transmit an RRCReconfigurationComplete message to the network entity 105-a.

The network entity 105-a may output second information 320 to the UE 115-b. The UE 115-b may receive the second information 320. The second information 320 may indicate a security configuration for securing UE communication. For instance, the security configuration may include a NCC value. The UE 115-b may utilize the NCC value to derive a security key for securing UE communication with the network entity 105-b after the first handover 340-a.

In some examples, the first information 315 indicating the at least one LTM candidate configuration and the second information 320 indicating the security configuration may be communicated (e.g., transmitted or received) in a same message. For instance, the first information 315 and the second information 320 may be communicated via one RRCReconfiguration message. In some examples, the first information 315 and the second information 320 may be received from one network entity (e.g., the network entity 105-a). In some examples, LTM candidate configuration information and security configuration information may be received from separate network entities.

In some examples, the UE 115-b may perform downlink synchronization and timing advance (TA) acquisition with one or more candidate cells before performing an LTM procedure (e.g., before receiving an LTM cell switch command). The UE 115-b may perform L1 measurements on the configured LTM candidate cell(s) and may transmit one or more lower-layer measurement reports to a network entity (e.g., network entity 105-a).

The UE 115-b may perform an LTM procedure to the cell 305-b based on the first information 315. For instance, the UE 115-b may utilize the LTM candidate configuration associated with the cell 305-b indicated by the first information 315 to perform the LTM procedure. The LTM procedure may be executed to perform the first handover 340-a from the cell 305-a to the cell 305-b. For the first handover 340-a, the network entity 105-a may be a source network entity and the network entity 105-b may be a target network entity.

In some examples, the network entity 105-a may output an indication (e.g., a cell switch command) to the UE 115-b to trigger the LTM procedure to the cell 305-b provided by the network entity 105-b. For instance, the network entity 105-a may output the indication (e.g., trigger or cell switch command) to the UE 115-b via a media access control (MAC) control element (CE). In some approaches, the network entity 105-a may determine to trigger an LTM cell switch to a target cell. The network entity 105-a may output (e.g., transmit) a MAC CE triggering the LTM cell switch by including a candidate configuration index of the target cell. The UE 115-b may switch to the configuration of the LTM target cell. In some cases, UE 115-b may perform a random access procedure towards the target cell if the TA is unavailable. In some approaches, the UE 115-b may indicate successful completion of the LTM cell switch to the target cell.

In some examples, the UE 115-b may trigger a conditional LTM procedure to perform the first handover 340-a from the cell 305-a to the cell 305-b. For instance, the UE 115-b may detect that one or more conditions for the conditional LTM procedure are satisfied and may detach from the cell 305-a and may access the cell 305-b to perform the first handover 340-a. In some examples, an indication of the one or more conditions may be transmitted to the UE 115-b from a network entity (e.g., network entity 105-a).

The UE 115-b may transmit a signal (not shown in FIG. 3) to the network entity 105-b based on the second information 320 that indicates the security configuration. For example, the UE 115-b may transmit one or more messages to the network entity 105-b using a security key that is derived from the NCC value of the security configuration.

In some aspects, the first information 315 may be retained (by the UE 115-b, for instance) for a subsequent handover (e.g., handover 340-b or handover 340-c) with an independently updated security configuration subsequent to the first handover 340-a that is based on the at least one LTM candidate configuration. For example, the UE 115-b may retain the first information 315 for one or more handovers subsequent to the first handover 340-a. The first information 315 may provide the LTM candidate configuration information of one or more candidate cells (e.g., the cell 305-a or the cell 305-c) for one or more handovers (the handover 340-b or the handover 340-c) subsequent to the first handover 340-a.

The UE 115-b may receive security information 330 from the network entity 105-b. The security information 330 may indicate an independently updated security configuration for securing UE 115-b communication for a subsequent handover (the handover 340-b or the handover 340-c). The security configuration may be independently updated by being updated independently from the LTM candidate configuration information. For instance, the UE 115-b may utilize the security information 330 from the network entity 105-b including a security configuration that is updated independently from the LTM candidate configuration, which may be retained from the first information 315 received before the first handover 340-a. The security information 330 may include a NCC value (e.g., an updated NCC value). In some approaches, the security information 330 (e.g., NCC value) may be output to the UE 115-b via an RRC message. Additionally, or alternatively, the security information 330 (e.g., NCC value) may be output to the UE 115-b via a MAC CE message. In a case of a MAC CE message for the NCC value, F1 interface signaling between a central unit (CU) and a distributed unit (DU) may be utilized.

In some aspects, the security information 330 may include an indication that the security configuration (from the network entity 105-b) is for an LTM procedure between network entities (e.g., from the network entity 105-b to the network entity 105-c, or from the network entity 105-b to the network entity 105-a). Additionally, or alternatively, the security information 330 may include an indication that the security configuration (from the network entity 105-b) is for an LTM procedure to the network entity 105-c, an LTM procedure to the network entity 105-a, an LTM procedure to a network entity included in a set of network entities that includes the network entity 105-c or the network entity 105-a, an LTM procedure to a cell 305-c provided by the network entity 105-c or to a cell 305-a provided by the network entity 105-a, an LTM procedure to a cell included in a set of cells that includes the cell 305-c provided by the network entity 105-c or the cell 305-a provided by the network entity 105-a, or any combination thereof.

In some aspects, the network entity 105-b may output the security information 330 (e.g., the independently updated security configuration) without updating the LTM candidate configuration associated with the UE 115-b. By independently updating the security configuration (without updating the LTM candidate configuration), control signaling may be reduced while enabling the UE 115-b to secure communications with a network entity (e.g., the network entity 105-a or network entity 105-c) after a subsequent handover. In some examples, the security information 330 may be communicated via an RRC message that indicates the security configuration (e.g., updated security configuration) without indicating an LTM candidate configuration.

In some examples, the first information 315 indicating the at least one LTM candidate configuration includes an LTM candidate configuration associated with the cell 305-c and the first LTM procedure is for the first handover 340-a. The UE 115-b may receive the security information 330 from the network entity 105-b subsequent to the first handover 340-a. The security information 330 may indicate a security configuration for securing UE communication (with the network entity 105-c via the cell 305-c, for example).

In some aspects, the UE 115-b may receive an indication from the network entity 105-b to trigger the second LTM procedure of the UE 115-b to the cell 305-c. In some aspects, the UE 115-b may trigger the second LTM procedure as a conditional LTM procedure based on one or more conditions of the conditional LTM procedure being satisfied.

In some examples, the UE 115-b may perform the second LTM procedure for the handover 340-b of the UE to the cell 305-c based on the first information 315. For instance, the UE 115-b may utilize the LTM candidate configuration of the cell 305-c indicated by the first information 315 to perform the handover 340-b. The UE 115-b may transmit a signal 325 via the cell 305-c based on the security information 330 indicating the security configuration. For the handover 340-b, the network entity 105-b may be a source network entity and the network entity 105-c may be a target network entity.

In some examples, the first information 315 indicating the at least one LTM candidate configuration may be received from another network entity (e.g., the network entity 105-a) that is different from the network entity (e.g., the network entity 105-b) from which the security information 330 indicating the security configuration is received. For instance, the UE 115-b may receive the first information 315 or perform an LTM procedure (for the first handover 340-a) of the UE 115-b to the cell 305-b provided by the network entity 105-b prior to receiving the security information 330.

In some aspects, the UE 115-b may receive an indication from the network entity 105-b to trigger the second LTM procedure of the UE 115-b to the cell 305-a. In some aspects, the UE 115-b may trigger the second LTM procedure as a conditional LTM procedure based on one or more conditions of the conditional LTM procedure being satisfied.

In some examples, the UE 115-b may perform the second LTM procedure for the handover 340-c of the UE 115-b to the cell 305-a based on the first information 315. For instance, the UE 115-b may utilize the LTM candidate configuration of the cell 305-a indicated by the first information 315 to perform the handover 340-b. The UE 115-b may transmit a signal (not shown in FIG. 3) via the cell 305-a based on the security information 330 indicating the security configuration. For the handover 340-c, the network entity 105-b may be a source network entity and the network entity 105-a may be a target network entity.

In some examples, the network entity 105-b may communicate information with the network entity 105-a via a backhaul communication link 120-a, or may communicate information with the network entity 105-c via a backhaul communication link 120-b. For instance, backhaul communications may be performed to coordinate the handover 340-a, the handover 340-b, or the handover 340-c.

In some examples, the network entity 105-b may output the indication of the security configuration to one or more network entities that provide one or more candidate cells. For instance, the network entity 105-b may output an indication (via the backhaul link 120-a or the backhaul link 120-b) of the security configuration to the network entity 105-a (that provides a cell 305-a that is associated with the at least one LTM candidate configuration for the UE 115-b) or to the network entity 105-c (that provides a cell 305-c that is associated with the at least one LTM candidate configuration for the UE 115-b). In some aspects, the indication may indicate an NCC value and a key value associated with the cell 305-a provided by the network entity 105-a or may indicate an NCC value and a key value associated with the cell 305-c provided by the network entity 105-c. In one example, the network entity 105-b may output the indication to the network entity 105-a via the backhaul communication link 120-a and to the network entity 105-c via the backhaul communication link 120-b.

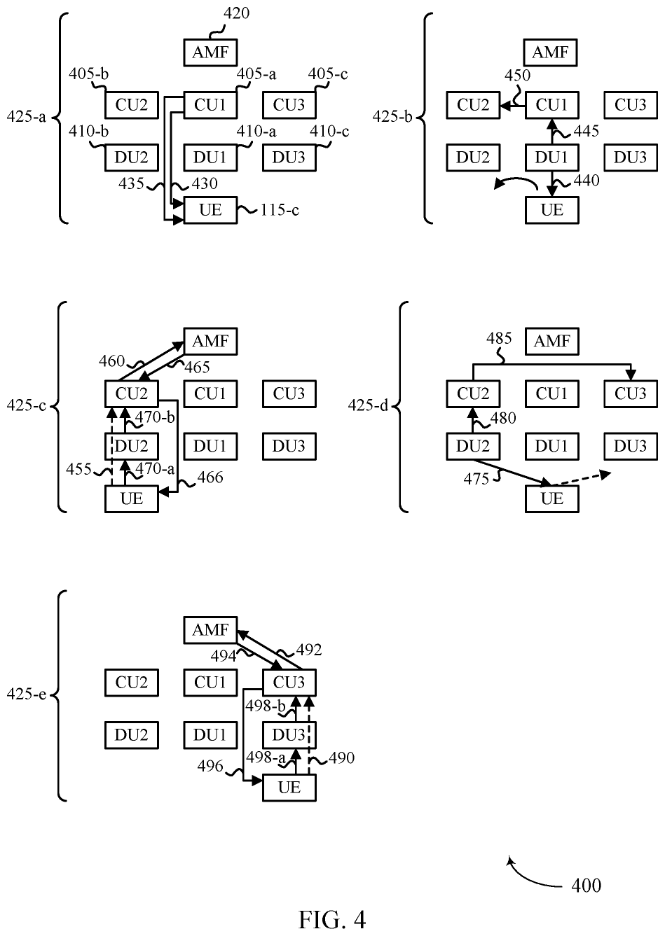

In some scenarios, the indication of the security configuration may be outputted concurrently with an LTM procedure or subsequent to an LTM procedure (e.g., with or after an LTM procedure for the handover 340-b). For example, the UE 115-b may execute an LTM procedure to perform the handover 340-b before the network entity 105-c receives the indication of the security configuration (e.g., the NCC value or the key value) from the network entity 105-b. Additionally, or alternatively, the signal 325 may be transmitted to the network entity 105-c before the network entity 105-c receives the indication of the security configuration (e.g., the NCC value or the key value) from the network entity 105-b. The network entity 105-c may buffer the signal 325 until the indication (e.g., the NCC value or the key value) is received. After the indication of the security configuration is received, the network entity 105-c may process the signal 325 based on the indication of the security configuration. In some of the examples described with reference to FIG. 4, the indication of the security configuration may be communicated concurrently with or after a handover.

In some examples, the cell 305-c may be a target cell for the LTM procedure for the handover 340-b. For instance, the network entity 105-b may be a source network entity providing the cell 305-b as a source cell, and the network entity 105-c may be a target network entity providing the cell 305-c as a target cell. The network entity 105-c may obtain, from the network entity 105-b (via the backhaul communication link 120-b, for example), an indication of triggering the LTM procedure of the UE 115-b to the cell 305-c provided by the network entity 105-c. As described herein, the cell 305-c may be associated with the at least one LTM candidate configuration (from the first information 315, for example) for the second handover 340-b with an independently updated security configuration subsequent to the first handover 340-a.

The network entity 105-b may output (via the backhaul communication link 120-b, for example) the indication of the security configuration to the network entity 105-c. The security configuration may include a next hop (NH) value, an NCC value, or the key value. The network entity 105-c may obtain the indication, which may enable the UE 115-b to communicate with the network entity 105-c after the handover 340-b.

The network entity 105-c may obtain (e.g., receive) the signal 325 from the UE 115-b. In some examples, the signal 325 may be a message indicating a completion of the LTM procedure to the cell 305-c (e.g., the target cell). For instance, the signal may be an RRC reconfiguration complete message. The network entity 105-c may communicate with the UE 115-b based on the signal 325 (e.g., message) and the indication. For instance, the network entity 105-c may utilize the indication (e.g., the NH value, the NCC value, or the key value) to authenticate the UE 115-b or to secure communication with the UE 115-b (e.g., perform encryption or decryption for one or more communications with the UE 115-b).

As described herein, the network entity 105-c may obtain (e.g., receive) the signal 325 (e.g., the message) prior to obtaining the indication of the security configuration in some cases. The network entity 105-c may buffer the signal 325 (e.g., the message) to process the signal 325 subsequent to obtaining the indication of the security configuration.

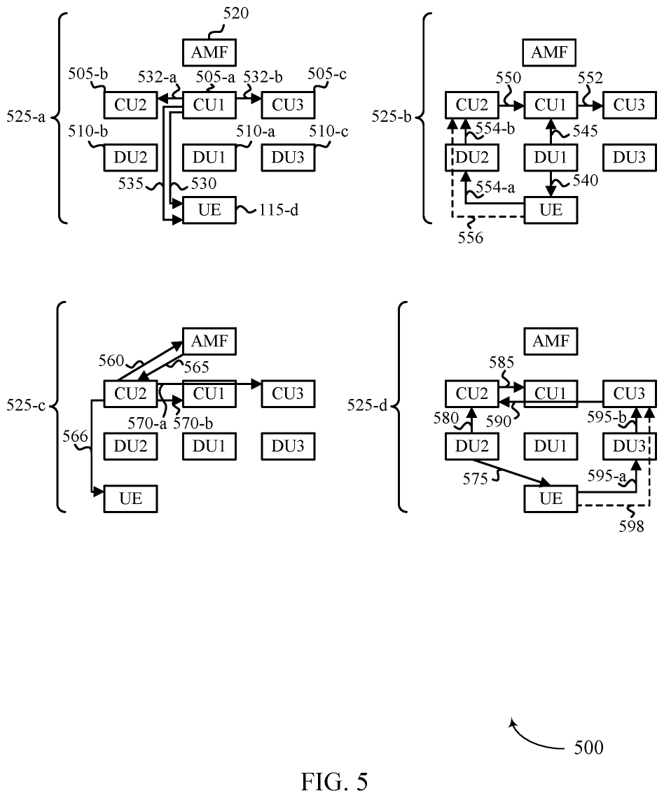

In some examples, the indication of the security configuration may be outputted prior to an LTM procedure or prior to outputting the security information 330 to the UE 115-b (e.g., before outputting the security configuration or before an LTM procedure for the handover 340-b). For instance, the network entity 105-b may output the indication of the security configuration to the network entity 105-a and to the network entity 105-c for a potential handover. Outputting the security configuration in advance may help to avoid a scenario (e.g., a post-handover communication delay) in which a network entity (e.g., network entity 105-c) buffers a signal (e.g., the signal 325) until an indication of a security configuration is received. In some of the examples described with reference to FIG. 5, the indication of the security configuration may be communicated before a handover.

In some scenarios, the network entity 105-b may output the indication of the security configuration to the network entity 105-a (that provides a cell 305-a that is associated with the at least one LTM candidate configuration for the UE 115-b) and to the network entity 105-c (that provides a cell 305-c that is associated with the at least one LTM candidate configuration for the UE 115-b), where the cell 305-c provided by the network entity 105-c is a target cell or becomes a target cell for the handover 340-b. For example, the cell 305-a may be a candidate cell that does not become a target cell for the LTM procedure for the handover 340-b. In some approaches, the network entity 105-b may output a second indication to the network entity 105-a to invalidate the indication of the security configuration based on the performance of the LTM procedure of the UE 115-b to the cell 305-c (the target cell in this example). For instance, the cell 305-a may be a candidate cell that is associated with the at least one LTM candidate configuration for the UE 115-b, but because the cell 305-a was not selected as a target cell for the LTM procedure, the network entity 105-a may invalidate the security configuration based on the second indication.

In some examples of the techniques described herein, the network entity 105-b may obtain at least part of a security configuration from an AMF entity. For instance, the network entity 105-b may obtain at least part of a security configuration from an AMF entity associated with the UE 115-b for outputting the security information 330 to the UE 115-b. In some approaches, the network entity 105-b may output a path switch request to the AMF entity (based on a message or an indication indicating completion of an LTM procedure, for example). The network entity 105-b may obtain an acknowledgment of the path switch request with an updated NH value and an updated NCC value. In some aspects, the at least part of the security configuration may include the NCC value or an indication for the network entity 105-b to utilize a fresh key. In some approaches, the network entity 105-b may output an NCC value of zero to the UE 115-b in response to the indication for the network entity 105-b to utilize the fresh key.

In some examples, the network entity 105-b may include a central unit (CU) and a distributed unit (DU). The CU may output the security information 330 to the UE 115-b via the DU, the DU may output an indication to trigger the LTM procedure to the UE 115-b, the DU may output an indication of triggering the first LTM procedure to the CU, the CU may output an indication of the security configuration to another network entity (e.g., the network entity 105-b, the network entity 105-c, or a combination thereof). Examples of obtaining at least part of the security configuration with an AMF are provided with respect to FIG. 4 and FIG. 5.

FIG. 4 shows an example of a wireless communications system 400 that supports security aspects for LTM in accordance with one or more aspects of the present disclosure. The wireless communications system 400 includes a first CU 405-a, a first DU 410-a, a second CU 405-b, a second DU 410-b, a third CU 405-c, a third DU 410-c, a UE 115-c, and an AMF entity 420. Specifically, FIG. 4 illustrates first operations 425-a, second operations 425-b, third operations 425-c, fourth operations 425-d, and fifth operations 425-e of the wireless communications system 400 in accordance with some examples of the techniques described herein. For convenience in illustration, the first CU 405-a is illustrated as “CU1,” the second CU 405-b is illustrated as “CU2,” the third CU 405-c is illustrated as “CU3,” the first DU 410-a is illustrated as “DU1,” the second DU 410-b is illustrated as “DU2,” the third DU 410-c is illustrated as “DU3,” the UE 115-c is illustrated as the “UE,” and the AMF entity 420 is illustrated as the “AMF.” For convenience in element numbering, the element numbers for the first CU 405-a, the second CU 405-b, the third CU 405-c, the first DU 410-a, the second DU 410-b, the third DU 410-c, the UE 115-c, and the AMF entity 420 are shown with respect to the first operations 425-a and are omitted with respect to the second operations 425-b, the third operations 425-c, the fourth operations 425-d, and the fifth operations 425-e. While omitted with respect to the second operations 425-b, the third operations 425-c, the fourth operations 425-d, and the fifth operations 425-e, the element numbers shown with respect to the first operations 425-a also apply to the corresponding elements of the second operations 425-b, the third operations 425-c, the fourth operations 425-d, and the fifth operations 425-e.

The wireless communications system 400 may implement aspects of or may be implemented by aspects of the wireless communications system 100, of the network architecture 200, or of the wireless communications system 300. For example, the wireless communications system 400 includes the UE 115-c, which may be an example of a UE 115 described with respect to FIG. 1, a UE 115-a described with respect to FIG. 2, or a UE 115-b described with respect to FIG. 3. The first CU 405-a, the second CU 405-b, or the third CU 405-c may be examples of the CU 160-a described with respect to FIG. 2. The first DU 410-a, the second DU 410-b, or the third DU 410-c may be examples of the DU 165-a described with respect to FIG. 2.

In some examples, the first CU 405-a and the first DU 410-a may be included in a first network entity, the second CU 405-b and the second DU 410-b may be included in a second network entity, or the third CU 405-c and the third DU 410-c may be included in a third network entity. One or more of the network entities may be examples of a network entity 105 as described with respect to FIG. 1, or may be examples of one or more of the network entities 105-a, 105-b, 105-c described with respect to FIG. 3.

In this example with respect to the first operations 425-a, the UE 115-c may be initially served by a first cell that is provided by a first network entity (e.g., the first CU 405-a and the first DU 410-a). The first CU 405-a may output an LTM candidate configuration 430 to the UE 115-c. For instance, the UE 115-c may be configured with candidate network entities or cells for subsequent LTM, where the candidate network entities or cells include the first network entity or first cell, the second network entity or second cell, and the third network entity or third cell. The first CU 405-a may output an NCC value 435 to the UE 115-c for a next inter-CU LTM procedure.

With respect to the second operations 425-b, the first DU 410-a may output a trigger 440 for an LTM procedure of the UE 115-c to the second network entity or second cell. The first DU 410-a may output an LTM trigger notification 445 to the first CU 405-a. For instance, the LTM trigger notification 445 may notify the first CU 405-a that the UE 115-c has been triggered to handover to the second network entity or second cell. The first CU 405-a may provide a notification 450 to the second CU 405-b. The notification 450 may indicate the LTM trigger of the UE 115-c to the second network entity or second cell, may indicate an NCC value to be utilized by the UE 115-c, or may indicate a key value. For instance, the first CU 405-a may provide the NCC value to the second CU 405-b that was previously provided to the UE 115-c (with respect to the first operations 425-a) with a corresponding key value.

With respect to the third operations 425-c, the UE 115-c may access the second network entity or second cell. To access the second network entity or second cell, the UE 115-c may transmit an access notification 455 to the second CU 405-b. For instance, the UE 115-c may transmit a first access message 470-a to the second DU 410-b, which the second DU 410-b may relay to the second CU 405-b via a second access message 470-b. The second CU 405-b may perform a path switch procedure with the AMF entity 420. For example, the second CU 405-b may output a path switch request 460 to the AMF entity 420. The AMF entity 420 may send a path switch acknowledgment 465 with an updated NH value or an updated NCC value. The second CU 405-b may output the NCC value 466 to the UE 115-c for a subsequent inter-CU LTM procedure. The NCC value 466 may be based on the updated NCC value provided by the AMF entity 420.

With respect to the fourth operations 425-d, the second DU 410-b outputs a trigger 475 for an LTM procedure of the UE 115-c to the third network entity or third cell. The second DU 410-b outputs an LTM trigger notification 480 to the second CU 405-b. For instance, the LTM trigger notification 480 may notify the second CU 405-b that the UE 115-c has been triggered to handover to the third network entity or third cell. The second CU 405-b provides a notification 485 to the third CU 405-b. The notification 485 may indicate the LTM trigger of the UE 115-c to the third network entity or third cell, may indicate an NCC value to be utilized by the UE 115-c, or may indicate a key value. For instance, the second CU 405-b may provide the NCC value to the third CU 405-c that was previously provided to the UE 115-c (with respect to the third operations 425-c) with a corresponding key value.

With respect to the fifth operations 425-e, the UE 115-c may access the third network entity or third cell. To access the third network entity or third cell, the UE 115-c may transmit an access notification 490 to the third CU 405-c. For instance, the UE 115-c may transmit a first access message 498-a to the third DU 410-c, which the third DU 410-c may relay to the third CU 405-c via a second message 498-b. The third CU 405-c may perform a path switch procedure with the AMF entity 420. For example, the third CU 405-c may output a path switch request 492 to the AMF entity 420. The AMF entity 420 may send a path switch acknowledgment 494 with an updated NH value or an updated NCC value. The third CU 405-c may output the NCC value 496 to the UE 115-c for a subsequent inter-CU LTM procedure. The NCC value 496 may be based on the updated NCC value provided by the AMF entity 420.

FIG. 5 shows an example of a wireless communications system 500 that supports security aspects for LTM in accordance with one or more aspects of the present disclosure. The wireless communications system 500 includes a first CU 505-a, a first DU 510-a, a second CU 505-b, a second DU 510-b, a third CU 505-c, a third DU 510-c, a UE 115-d, and an AMF entity 520. Specifically, FIG. 5 illustrates first operations 525-a, second operations 525-b, third operations 525-c, and fourth operations 525-d of the wireless communications system 500 in accordance with some examples of the techniques described herein. For convenience in illustration, the first CU 505-a is illustrated as “CU1,” the second CU 505-b is illustrated as “CU2,” the third CU 505-c is illustrated as “CU3,” the first DU 510-a is illustrated as “DU1,” the second DU 510-b is illustrated as “DU2,” the third DU 510-c is illustrated as “DU3,” the UE 115-d is illustrated as the “UE,” and the AMF entity 520 is illustrated as the “AMF.” For convenience in element numbering, the element numbers for the first CU 505-a, the second CU 505-b, the third CU 505-c, the first DU 510-a, the second DU 510-b, the third DU 510-c, the UE 115-d, and the AMF entity 520 are shown with respect to the first operations 525-a and are omitted with respect to the second operations 525-b, the third operations 525-c, and the fourth operations 525-d. While omitted with respect to the second operations 525-b, the third operations 525-c, and the fourth operations 525-d, the element numbers shown with respect to the first operations 525-a also apply to the corresponding elements of the second operations 525-b, the third operations 525-c, and the fourth operations 525-d.

The wireless communications system 500 may implement aspects of or may be implemented by aspects of the wireless communications system 100, of the network architecture 200, of the wireless communications system 300, or of the wireless communications system 400. For example, the wireless communications system 500 includes the UE 115-d, which may be an example of a UE 115 described with respect to FIG. 1, a UE 115-a described with respect to FIG. 2, a UE 115-b described with respect to FIG. 3, or a UE 115-c described with respect to FIG. 4. The first CU 505-a, the second CU 505-b, or the third CU 505-c may be examples of the CU 160-a described with respect to FIG. 2. The first DU 510-a, the second DU 510-b, or the third DU 510-c may be examples of the DU 165-a described with respect to FIG. 2.

In some examples, the first CU 505-a and the first DU 510-a may be included in a first network entity, the second CU 505-b and the second DU 510-b may be included in a second network entity, or the third CU 505-c and the third DU 510-c may be included in a third network entity. One or more of the network entities may be examples of a network entity 105 as described with respect to FIG. 1, or may be examples of one or more of the network entities 105-a, 105-b, 105-c described with respect to FIG. 3.

In this example with respect to the first operations 525-a, the UE 115-d may be initially served by a first cell that is provided by a first network entity (e.g., the first CU 505-a and the first DU 510-a). The first CU 505-a may output an LTM candidate configuration 530 to the UE 115-d. For instance, the UE 115-d may be configured with candidate network entities or cells for subsequent LTM, where the candidate network entities or cells include the first network entity or first cell, the second network entity or second cell, and the third network entity or third cell.

The first CU 505-a may output (to the second CU 505-b and the third CU 505-c or each candidate CU) security values (e.g., an NCC value and a key value) associated with each candidate cell. For instance, the first CU 505-a may output the security values 532-a (e.g., an NCC value to be utilized by the UE 115-d and a key value for the second (candidate) cell) to the second CU 505-b. Additionally, or alternatively, the first CU 505-a may output the security values 532-b (e.g., an NCC value to be utilized by the UE 115-d and a key value for the third (candidate) cell) to the third CU 505-c. In some examples, outputting the security values (e.g., NCC values and key values) may be performed as part of LTM preparation. The first CU 505-a may output an NCC value 535 to the UE 115-d for a next inter-CU LTM procedure.

With respect to the second operations 525-b, the first DU 510-a may output a trigger 540 for an LTM procedure of the UE 115-d to the second network entity or second cell. The first DU 510-a may output an LTM trigger notification 545 to the first CU 505-a. For instance, the LTM trigger notification 545 may notify the first CU 505-a that the UE 115-d has been triggered to handover to the second network entity or second cell. The UE 115-d may access the second network entity or second cell. To access the second network entity or second cell, the UE 115-d may transmit an access notification 556 to the second CU 505-b. For instance, the UE 115-d may transmit a first access message 554-a to the second DU 510-b, which the second DU 510-b may relay to the second CU 505-b via a second access message 554-b.

The second CU 505-b may provide a notification 550 to the first CU 505-a. The notification 550 may indicate handover success of the UE 115-d to the second network entity or second cell. The first CU 505-a may output an indication 552 to the third CU 505-c to invalidate the key value previously provided to the third CU 505-c. The indication 552 may indicate the NCC value or the key value. The third CU 505-c may invalidate the key value (e.g., may mark the key value as invalid or discard the key value).

With respect to the third operations 525-c, The second CU 505-b may perform a path switch procedure with the AMF entity 520. For example, the second CU 505-b may output a path switch request 560 to the AMF entity 520. The AMF entity 520 may send a path switch acknowledgment 565 with an updated NH value or an updated NCC value. The second CU 505-b may output (to the first CU 505-a and the third CU 505-c or each candidate CU) an NCC value and a key value associated with each candidate cell. The NCC value 566 may be based on the updated NCC value provided by the AMF entity 520. For instance, the second CU 505-b may output an indication 570-b of the NCC value to be utilized by the UE 115-d and a key value for the first (candidate) cell to the first CU 505-a. Additionally, or alternatively, the second CU 505-b may output an indication 570-a of the NCC value to be utilized by the UE 115-d and a key value for the third (candidate) cell to the third CU 505-c. The second CU 505-b may output an NCC value 566 to the UE 115-d for a next inter-CU LTM procedure.

With respect to the fourth operations 525-d, the second DU 510-b may output a trigger 575 for an LTM procedure of the UE 115-d to the third network entity or third cell. The second DU 510-b may output an LTM trigger notification 580 to the second CU 505-b. For instance, the LTM trigger notification 580 may notify the second CU 505-b that the UE 115-d has been triggered to handover to the third network entity or third cell. The UE 115-d may access the second network entity or second cell. To access the second network entity or second cell, the UE 115-d may transmit an access notification 598 to the third CU 505-c. For instance, the UE 115-d may transmit a first access message 595-a to the third DU 510-c, which the third DU 510-c may relay to the third CU 505-c via a second access message 595-b.

The third CU 505-c may provide a notification 590 to the second CU 505-b. The notification 590 may indicate handover success of the UE 115-d to the third network entity or third cell. The second CU 505-b may output an indication 585 to the third CU 505-c to invalidate the key value previously provided to the first CU 505-a. The indication 585 may indicate the NCC value or the key value. The third CU 505-c may invalidate the key value (e.g., may mark the key value as invalid or discard the key value).

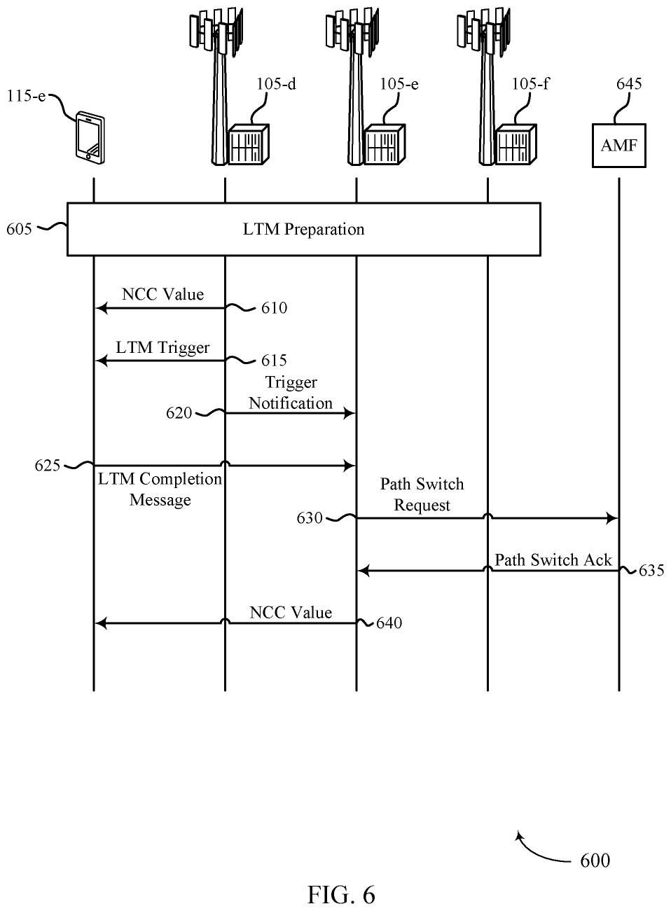

FIG. 6 shows an example of a process flow 600 that supports security aspects for LTM in accordance with one or more aspects of the present disclosure. The process flow 600 may include a UE 115-e, which may be an example of one or more of the UEs 115, 115-b, 115-c, 115-d as described herein with reference to FIG. 1, FIG. 2, FIG. 3, FIG. 4, or FIG. 5. The process flow 600 may also include a network entity 105-d, a network entity 105-e, and a network entity 105-f, which may be examples of one or more of the network entities 105, 105-a, 105-b, 105-c as described herein with reference to FIG. 1, FIG. 3, FIG. 4, or FIG. 5. The process flow 600 may include an AMF entity 645, which may be an example of one or more of the AMF entities 420, 520 as described herein with reference to FIG. 1, FIG. 3, FIG. 4, or FIG. 5.

In the following description of the process flow 600, the operations between the network entity 105-d, the network entity 105-e, the network entity 105-f, the UE 115-e, or the AMF entity 645 may be performed in a different order than the example order shown, or the operations performed by the network entity 105-d, the network entity 105-e, the network entity 105-f, the AMF entity 645, or the UE 115-e may be performed in different orders or at different times. Some operations may be omitted from the process flow 600, or other operations may be added to the process flow 600.

At 605, the network entity 105-d, the network entity 105-e, the network entity 105-f, or the UE 115-e may perform LTM preparation. In some aspects, the (serving) network entity 105-d may output an indication of one or more LTM candidate configurations to the UE 115-e as described with reference to one or more of FIG. 1, FIG. 3, FIG. 4, or FIG. 5.

At 610, the UE 115-e may receive, from the network entity 105-d, an NCC value. For example, the (serving) network entity 105-d may indicate, based on a key value available at the network entity 105-d, an NCC value to be utilized by the UE 115-e for a subsequent LTM procedure. The NCC value may be indicated to the UE 115-e via an RRC message in some examples. In some aspects, providing the NCC value to the UE 115-e may be performed as described with reference to one or more of FIG. 1, FIG. 3, FIG. 4, or FIG. 5.

At 615, the network entity 105-d may output an LTM trigger to the UE 115-e for an LTM procedure to a second cell provided by the network entity 105-e. In some aspects, providing the LTM trigger to the UE 115-e may be performed as described with reference to one or more of FIG. 1, FIG. 3, FIG. 4, or FIG. 5. In some approaches, the UE 115-e may not apply a security update based on the NCC value (e.g., key value reception) until after LTM triggering.

At 620, the network entity 105-d may output a trigger notification to the network entity 105-e. For example, the network entity 105-d may output an LTM trigger indication with a key value and an NCC value to be used by the UE 115-e. In some aspects, providing the LTM trigger indication to the network entity 105-e may be performed as described with reference to one or more of FIG. 1, FIG. 3, FIG. 4, or FIG. 5.

At 625, the UE 115-e may transmit an LTM completion message to the network entity 105-e. For instance, the UE 115-e may transmit an RRCReconfiguration complete message based on the NCC value for the LTM procedure. In some aspects, providing the LTM completion message to the network entity 105-e may be performed as described with reference to one or more of FIG. 1, FIG. 3, FIG. 4, or FIG. 5.

At 630, the network entity 105-e may output a path switch request to the AMF entity 645. In some aspects, outputting the path switch request to the AMF entity 645 may be performed as described with reference to one or more of FIG. 1, FIG. 3, FIG. 4, or FIG. 5.

At 635, the AMF entity 645 may output a path switch acknowledgment to the network entity 105-e. For instance, the AMF entity 645 may output a path switch acknowledgment with an updated NH value or updated (e.g., fresh) NCC value. In some aspects, outputting the path switch acknowledgment to the network entity 105-e may be performed as described with reference to one or more of FIG. 1, FIG. 3, FIG. 4, or FIG. 5.

At 640, the (target) network entity 105-e may output the updated NCC value to the UE 115-e for a next LTM procedure. For instance, the network entity 105-e may output the updated (e.g., fresh) NCC value to the UE 115-e via an RRC message. In some examples, the (target) network entity 105-e may provide the NCC value based on the reception of the updated key value or NCC value from the AMF entity 645 during a path switch procedure. The updated NCC value may be provided to the UE 115-e independent of the LTM preparation (e.g., without updating or signaling an LTM candidate configuration). In some aspects, outputting the NCC value to the UE 115-e may be performed as described with reference to one or more of FIG. 1, FIG. 3, FIG. 4, or FIG. 5.

In some examples, the UE 115-e may perform one or more subsequent LTM procedures (for handover to the network entity 105-f, for instance) utilizing the LTM candidate configuration(s) from the initial LTM preparation. For instance, the UE 115-e may utilize the NCC value received from the network entity 105-e to perform an LTM procedure to the network entity 105-f without updating the LTM candidate configuration(s).

In some examples of the techniques described herein, a (serving) network entity 105-d may request a key value from the AMF entity 645 for an LTM procedure. The (serving) network entity 105-d may receive the key value and an NCC value, and may configure the NCC value on the UE 115-e before LTM triggering.

In some scenarios, a UE may perform horizontal key derivation for a first LTM inter-CU handover and vertical key derivation for one or more subsequent handovers. In some scenarios, a UE may not perform horizontal key derivation for a first LTM inter-CU handover and vertical key derivation for one or more subsequent handovers. In some aspects, a first LTM handover may occur after LTM is configured by a network entity. A UE may have been configured with LTM by a network entity after previously performing an L3 mobility procedure from a previous network entity to the current network entity. In this case, the network entity gNB1 may have a fresh NH value or a fresh NCC value (e.g., pair) which the network entity may determine to not use immediately. Accordingly, a first inter-CU LTM handover may involve vertical key derivation in some cases. For one or more subsequent LTM handovers, after each target network entity performs a path switch procedure and receives a new NCC value, the network entity may determine to utilize the new NCC value immediately (before a next LTM handover is triggered) while the UE is served by a target network entity. In this case, the NCC value for the next LTM procedure may be the same in accordance with horizontal key derivation.

In some examples of the techniques described herein, a UE may transmit capability signaling to a network entity. The capability signaling may indicate that the UE is capable of performing an independent security update for one or more LTM procedures. In some aspects, a network entity may output (in response to the capability signaling, for instance), configuration information for configuring the UE to receive independent security update information for one or more LTM procedures.

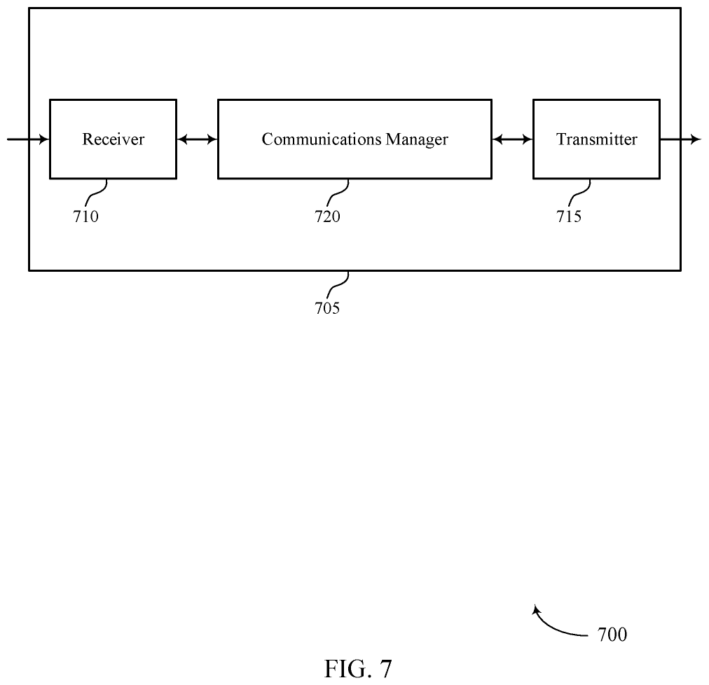

FIG. 7 shows a block diagram 700 of a device 705 that supports security aspects for LTM in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to security aspects for LTM). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to security aspects for LTM). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of security aspects for LTM as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

For example, the communications manager 720 is capable of, configured to, or operable to support a means for receiving first information indicating at least one LTM candidate configuration associated with a second cell provided by a second network entity, where the first information is retained for a second handover with an independently updated security configuration subsequent to a first handover that is based on the at least one LTM candidate configuration. The communications manager 720 is capable of, configured to, or operable to support a means for receiving second information from a first network entity, the second information indicating a first security configuration for securing UE communication. The communications manager 720 is capable of, configured to, or operable to support a means for performing a first LTM procedure for a handover (e.g., first handover, second handover, or another handover) of the UE to the second cell based on the first information. The communications manager 720 is capable of, configured to, or operable to support a means for transmitting a signal to the second network entity based on the second information indicating the first security configuration.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, or more efficient utilization of communication resources.

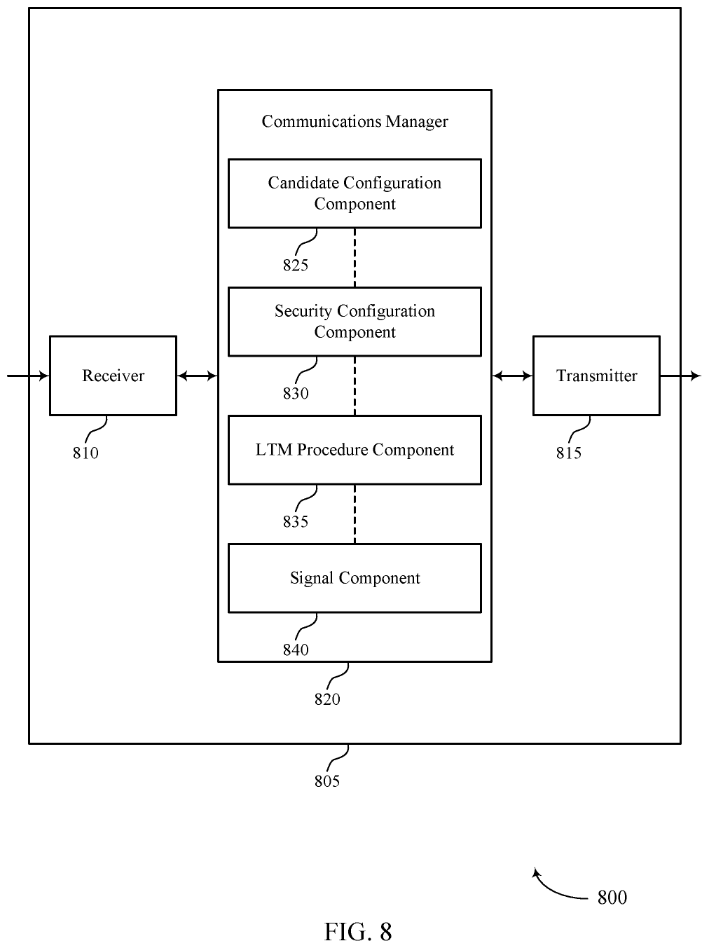

FIG. 8 shows a block diagram 800 of a device 805 that supports security aspects for LTM in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to security aspects for LTM). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to security aspects for LTM). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of security aspects for LTM as described herein. For example, the communications manager 820 may include a candidate configuration component 825, a security configuration component 830, an LTM procedure component 835, a signal component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The candidate configuration component 825 is capable of, configured to, or operable to support a means for receiving first information indicating at least one LTM candidate configuration associated with a second cell provided by a second network entity, where the first information is retained for a second handover with an independently updated security configuration subsequent to a first handover that is based on the at least one LTM candidate configuration. The security configuration component 830 is capable of, configured to, or operable to support a means for receiving second information from a first network entity, the second information indicating a first security configuration for securing UE communication. The LTM procedure component 835 is capable of, configured to, or operable to support a means for performing a first LTM procedure for a handover (e.g., first handover, second handover, or another handover) of the UE to the second cell based on the first information. The signal component 840 is capable of, configured to, or operable to support a means for transmitting a signal to the second network entity based on the second information indicating the first security configuration.

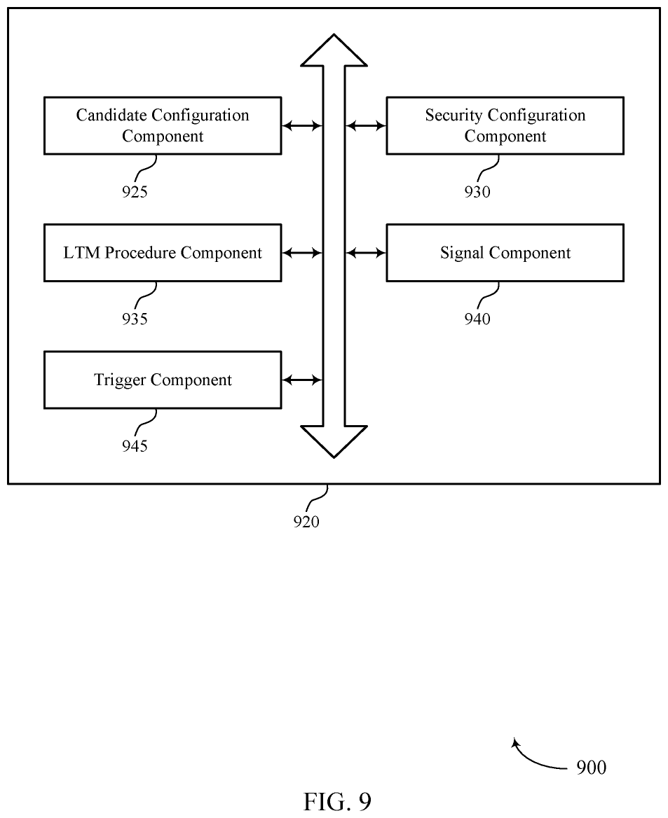

FIG. 9 shows a block diagram 900 of a communications manager 920 that supports security aspects for LTM in accordance with one or more aspects of the present disclosure. The communications manager 920 may be an example of aspects of a communications manager 720, a communications manager 820, or both, as described herein. The communications manager 920, or various components thereof, may be an example of means for performing various aspects of security aspects for LTM as described herein. For example, the communications manager 920 may include a candidate configuration component 925, a security configuration component 930, an LTM procedure component 935, a signal component 940, a trigger component 945, or any combination thereof. Each of these components, or components or subcomponents thereof (e.g., one or more processors, one or more memories), may communicate, directly or indirectly, with one another (e.g., via one or more buses).

The candidate configuration component 925 is capable of, configured to, or operable to support a means for receiving first information indicating at least one LTM candidate configuration associated with a second cell provided by a second network entity, where the first information is retained for a second handover with an independently updated security configuration subsequent to a first handover that is based on the at least one LTM candidate configuration. The security configuration component 930 is capable of, configured to, or operable to support a means for receiving second information from a first network entity, the second information indicating a first security configuration for securing UE communication. The LTM procedure component 935 is capable of, configured to, or operable to support a means for performing a first LTM procedure for a handover (e.g., first handover, second handover, or another handover) of the UE to the second cell based on the first information. The signal component 940 is capable of, configured to, or operable to support a means for transmitting a signal to the second network entity based on the second information indicating the first security configuration.

In some examples, the first information indicating the at least one LTM candidate configuration and the second information indicating the first security configuration are received in a same message.

In some examples, the first information indicating the at least one LTM candidate configuration comprises an LTM candidate configuration associated with a third cell and the first LTM procedure is for the first handover. In some examples, the security configuration component 930 is capable of, configured to, or operable to support a means for receiving third information from the second network entity subsequent to the first handover, the third information indicating a second security configuration for securing UE communication. In some examples, the trigger component 945 is capable of, configured to, or operable to support a means for receiving a second indication to trigger a second LTM procedure of the UE to the third cell. In some examples, the LTM procedure component 935 is capable of, configured to, or operable to support a means for performing the second LTM procedure for the second handover of the UE to the third cell based on the first information. In some examples, the signal component 940 is capable of, configured to, or operable to support a means for transmitting a second signal via the third cell based on the third information indicating the second security configuration.

In some examples, the first information indicating the at least one LTM candidate configuration and the second information indicating the first security configuration are received from different network entities.

In some examples, the LTM procedure component 935 may be capable of, configured to, or operable to support a means for performing a second LTM procedure for the first handover of the UE to a first cell provided by the first network entity prior to receiving the second information.

In some examples, the first security configuration includes a NCC value.

In some examples, the second information includes an indication that the first security configuration is for an LTM procedure between network entities, an LTM procedure to the second network entity, an LTM procedure to a network entity included in a set of network entities including the second network entity, an LTM procedure to a first cell provided by the first network entity, an LTM procedure to a cell included in a set of cells including a first cell provided by the first network entity, or any combination thereof.

In some examples, the first information and the second information are received from one network entity.

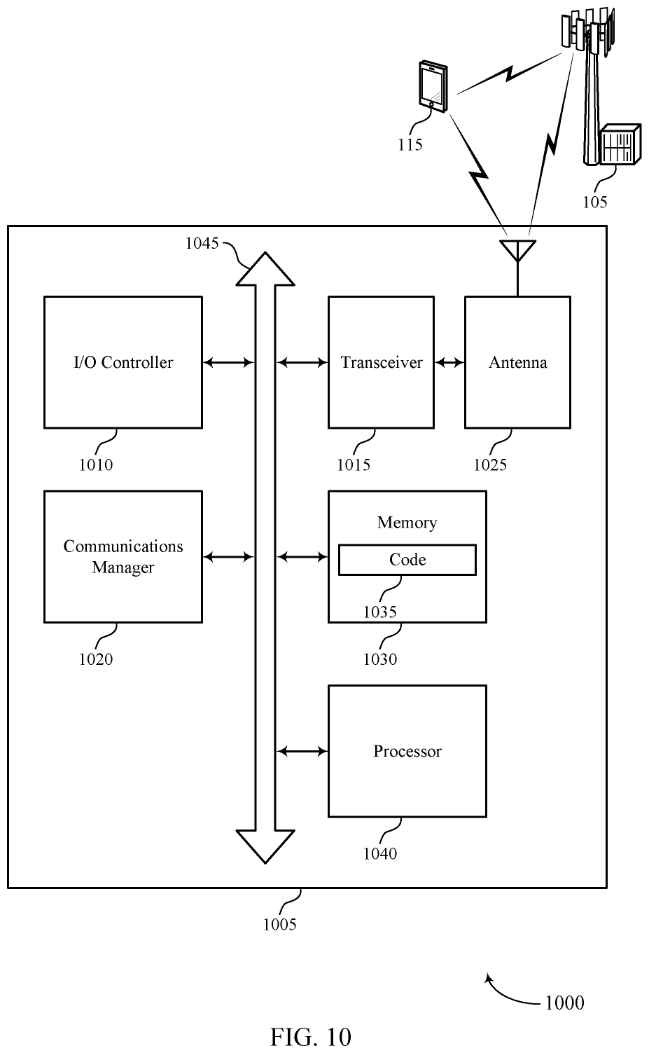

FIG. 10 shows a diagram of a system 1000 including a device 1005 that supports security aspects for LTM in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting security aspects for LTM). For example, the device 1005 or a component of the device 1005 may include at least one processor 1040 and at least one memory 1030 coupled with or to the at least one processor 1040, the at least one processor 1040 and the at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

For example, the communications manager 1020 is capable of, configured to, or operable to support a means for receiving first information indicating at least one LTM candidate configuration associated with a second cell provided by a second network entity, where the first information is retained for a second handover with an independently updated security configuration subsequent to a first handover that is based on the at least one LTM candidate configuration. The communications manager 1020 is capable of, configured to, or operable to support a means for receiving second information from a first network entity, the second information indicating a first security configuration for securing UE communication. The communications manager 1020 is capable of, configured to, or operable to support a means for performing a first LTM procedure for a handover (e.g., first handover, second handover, or another handover) of the UE to the second cell based on the first information. The communications manager 1020 is capable of, configured to, or operable to support a means for transmitting a signal to the second network entity based on the second information indicating the first security configuration.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of security aspects for LTM as described herein, or the at least one processor 1040 and the at least one memory 1030 may be otherwise configured to, individually or collectively, perform or support such operations.

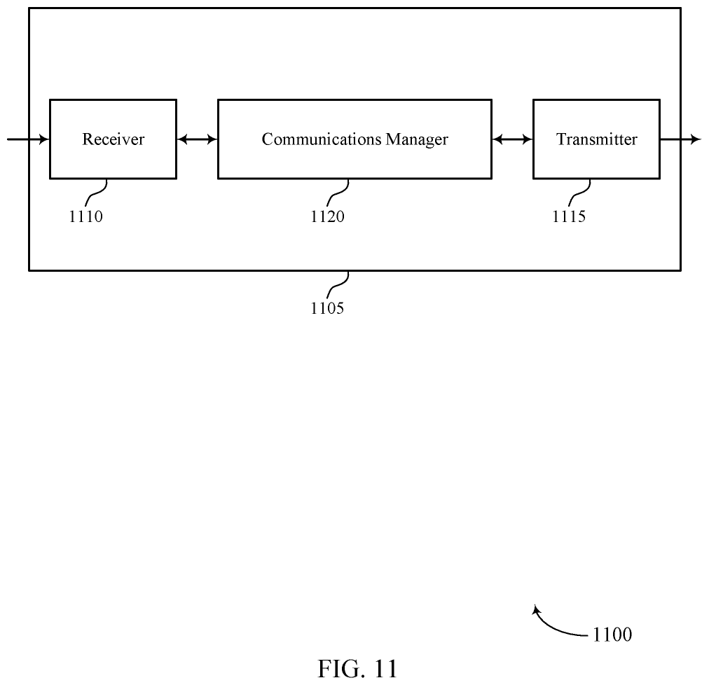

FIG. 11 shows a block diagram 1100 of a device 1105 that supports security aspects for LTM in accordance with one or more aspects of the present disclosure. The device 1105 may be an example of aspects of a source network entity as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of security aspects for LTM as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

For example, the communications manager 1120 is capable of, configured to, or operable to support a means for outputting second information to a UE, the second information indicating a first security configuration for securing UE communication. The communications manager 1120 is capable of, configured to, or operable to support a means for outputting a first indication from the source network entity to trigger a first LTM procedure for a handover (e.g., first handover, second handover, or another handover) of the UE to a second cell provided by a second network entity, where the second cell is associated with at least one LTM candidate configuration for a second handover with an independently updated security configuration subsequent to a first handover that is based on the at least one LTM candidate configuration.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, or more efficient utilization of communication resources.

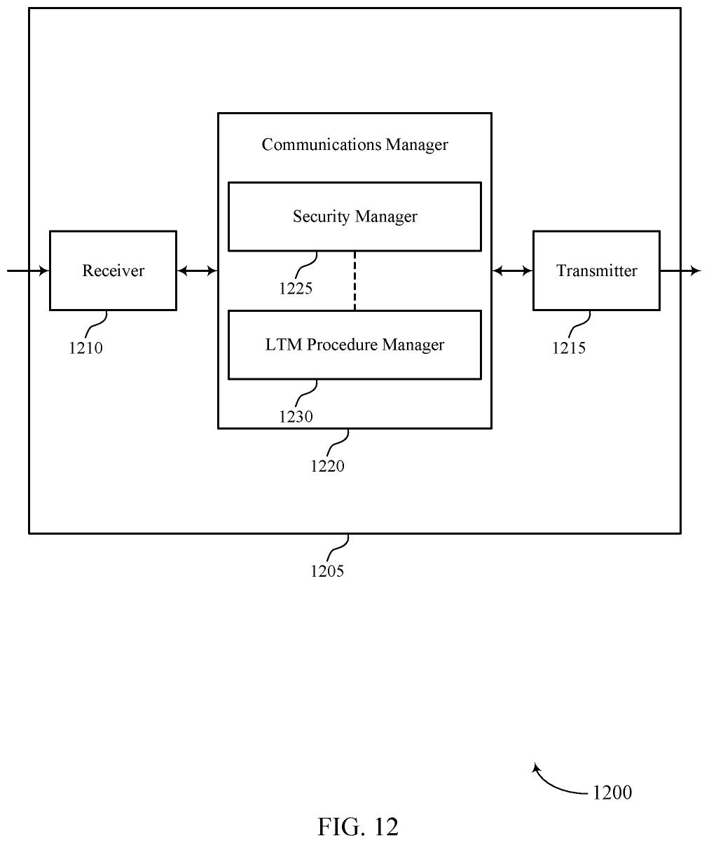

FIG. 12 shows a block diagram 1200 of a device 1205 that supports security aspects for LTM in accordance with one or more aspects of the present disclosure. The device 1205 may be an example of aspects of a device 1105 or a source network entity as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of security aspects for LTM as described herein. For example, the communications manager 1220 may include a security manager 1225 an LTM procedure manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The security manager 1225 is capable of, configured to, or operable to support a means for outputting second information to a UE, the second information indicating a first security configuration for securing UE communication. The LTM procedure manager 1230 is capable of, configured to, or operable to support a means for outputting a first indication from the source network entity to trigger a first LTM procedure for a handover (e.g., first handover, second handover, or another handover) of the UE to a second cell provided by a second network entity, where the second cell is associated with at least one LTM candidate configuration for a second handover with an independently updated security configuration subsequent to a first handover that is based on the at least one LTM candidate configuration.

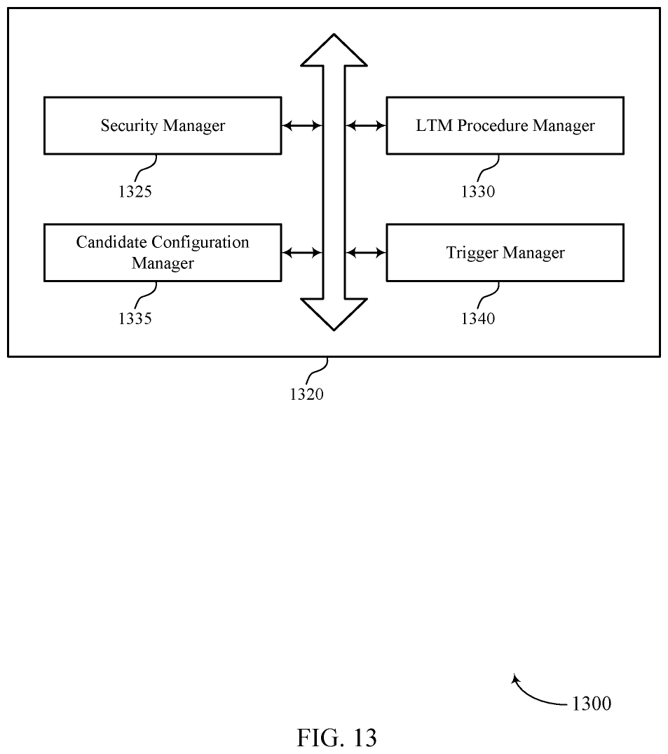

FIG. 13 shows a block diagram 1300 of a communications manager 1320 that supports security aspects for LTM in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of security aspects for LTM as described herein. For example, the communications manager 1320 may include a security manager 1325, an LTM procedure manager 1330, a candidate configuration manager 1335, a trigger manager 1340, or any combination thereof. Each of these components, or components or subcomponents thereof (e.g., one or more processors, one or more memories), may communicate, directly or indirectly, with one another (e.g., via one or more buses).

The security manager 1325 is capable of, configured to, or operable to support a means for outputting second information to a UE, the second information indicating a first security configuration for securing UE communication. The LTM procedure manager 1330 is capable of, configured to, or operable to support a means for outputting a first indication from the source network entity to trigger a first LTM procedure for a handover (e.g., first handover, second handover, or another handover) of the UE to a second cell provided by a second network entity, where the second cell is associated with at least one LTM candidate configuration for a second handover with an independently updated security configuration subsequent to a first handover that is based on the at least one LTM candidate configuration.

In some examples, the first security configuration includes a NCC value.

In some examples, the second information includes an indication that the first security configuration is for an LTM procedure between network entities, an LTM procedure to the second network entity, an LTM procedure to a network entity included in a set of network entities including the second network entity, an LTM procedure to a first cell provided by the source network entity, an LTM procedure to a cell included in a set of cells including a first cell provided by the source network entity, or any combination thereof.

In some examples, the candidate configuration manager 1335 is capable of, configured to, or operable to support a means for outputting first information to the UE, the first information indicating the at least one LTM candidate configuration associated with the second cell provided by the second network entity.

In some examples, the security manager 1325 is capable of, configured to, or operable to support a means for outputting an indication of the first security configuration to a network entity that provides a cell that is associated with the at least one LTM candidate configuration for the UE.

In some examples, the network entity is the second network entity and the cell is a target cell for the first LTM procedure for the first handover.

In some examples, the network entity is a third network entity separate from the second network entity and the cell is a third cell separate from a target cell for the first LTM procedure for the first handover.

In some examples, the indication further indicates a NCC value and a key value associated with the cell provided by the network entity.

In some examples, the indication is outputted concurrently with the first LTM procedure or subsequent to the first LTM procedure.

In some examples, the indication is outputted prior to the first LTM procedure or prior to outputting the second information to the UE.

In some examples, the security manager 1325 is capable of, configured to, or operable to support a means for outputting a second indication to the network entity to invalidate the indication of the first security configuration based on a performance of an LTM procedure of the UE to a target cell separate from the cell that is associated with the at least one LTM candidate configuration for the UE.

In some examples, the security manager 1325 is capable of, configured to, or operable to support a means for obtaining at least part of the first security configuration from an AMF entity associated with the UE for outputting the second information to the UE, the first security configuration including a NCC value or an indication for the source network entity to utilize a fresh key.

In some examples, the security manager 1325 is capable of, configured to, or operable to support a means for outputting an NCC value of zero to the UE in response to the indication for the source network entity to utilize the fresh key.

In some examples, the communications manager 1320 may include or may be implemented in a CU or a DU. In some examples, the security manager 1325 may be included in the CU and is capable of, configured to, or operable to support a means for outputting the second information to the UE via the DU. In some examples, the trigger manager 1340 may be included in a DU and is capable of, configured to, or operable to support a means for outputting the first indication to trigger the first LTM procedure to the UE. In some examples, the trigger manager 1340 is capable of, configured to, or operable to support a means for outputting an indication of triggering the first LTM procedure to the CU. In some examples, the security manager 1325 is capable of, configured to, or operable to support a means for outputting an indication of the first security configuration to the second network entity, a third network entity, or a combination thereof.

In some examples, the second network entity is the source network entity.

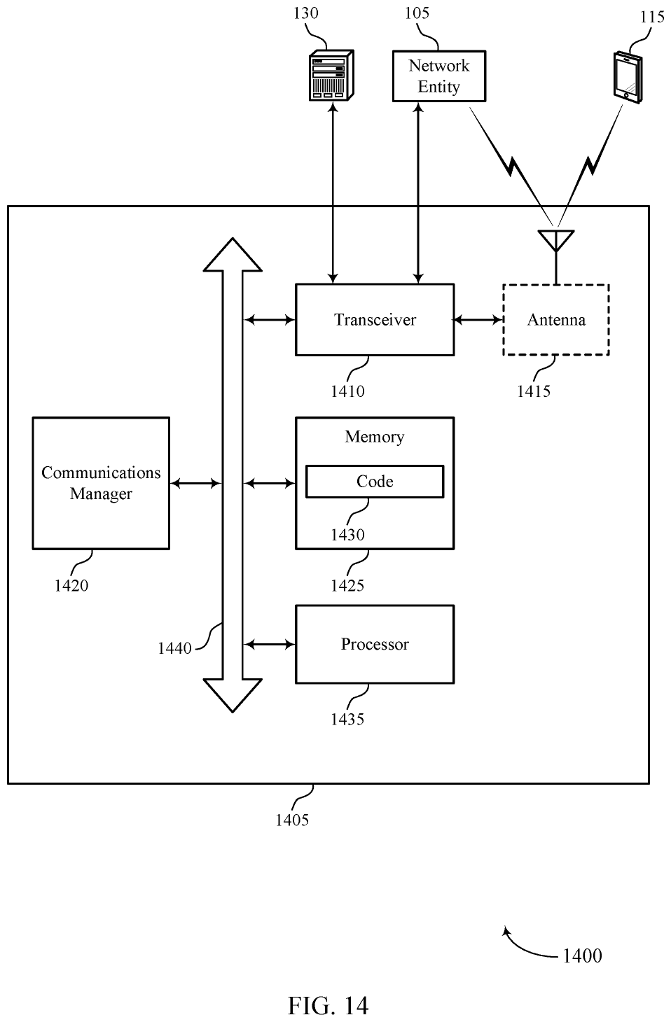

FIG. 14 shows a diagram of a system 1400 including a device 1405 that supports security aspects for LTM in accordance with one or more aspects of the present disclosure. The device 1405 may be an example of or include components of a device 1105, a device 1205, or a source network entity as described herein. The device 1405 may include components for bi-directional voice and data communications including components for transmitting and receiving communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting security aspects for LTM). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

For example, the communications manager 1420 is capable of, configured to, or operable to support a means for outputting second information to a UE, the second information indicating a first security configuration for securing UE communication. The communications manager 1420 is capable of, configured to, or operable to support a means for outputting a first indication from the source network entity to trigger a first LTM procedure for a handover (e.g., first handover, second handover, or another handover) of the UE to a second cell provided by a second network entity, where the second cell is associated with at least one LTM candidate configuration for a second handover with an independently updated security configuration subsequent to a first handover that is based on the at least one LTM candidate configuration.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of security aspects for LTM as described herein, or the at least one processor 1435 and the at least one memory 1425 may be otherwise configured to, individually or collectively, perform or support such operations.

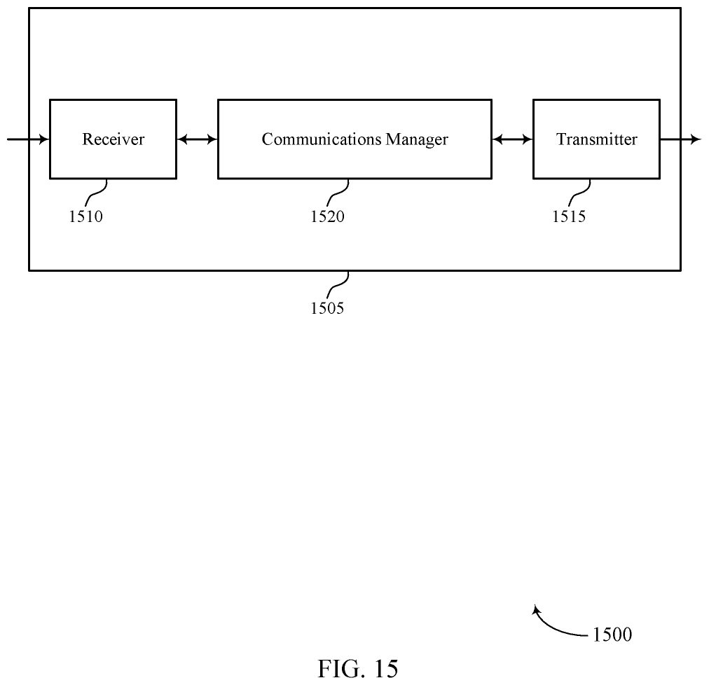

FIG. 15 shows a block diagram 1500 of a device 1505 that supports security aspects for LTM in accordance with one or more aspects of the present disclosure. The device 1505 may be an example of aspects of a target network entity as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The communications manager 1520, the receiver 1510, the transmitter 1515, or various combinations or components thereof may be examples of means for performing various aspects of security aspects for LTM as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

For example, the communications manager 1520 is capable of, configured to, or operable to support a means for obtaining, from a source network entity, an indication of triggering a first LTM procedure for a handover (e.g., first handover, second handover, or another handover) of a UE to a target cell provided by the target network entity, where the target cell is associated with at least one LTM candidate configuration for a second handover with an independently updated security configuration subsequent to a first handover that is based on the at least one LTM candidate configuration. The communications manager 1520 is capable of, configured to, or operable to support a means for obtaining an indication of a first security configuration for securing UE communication with the target network entity. The communications manager 1520 is capable of, configured to, or operable to support a means for obtaining a message from the UE indicating a completion of the LTM procedure to the target cell. The communications manager 1520 is capable of, configured to, or operable to support a means for communicating with the UE based on the message and the indication.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for reduced processing, reduced power consumption, or more efficient utilization of communication resources.

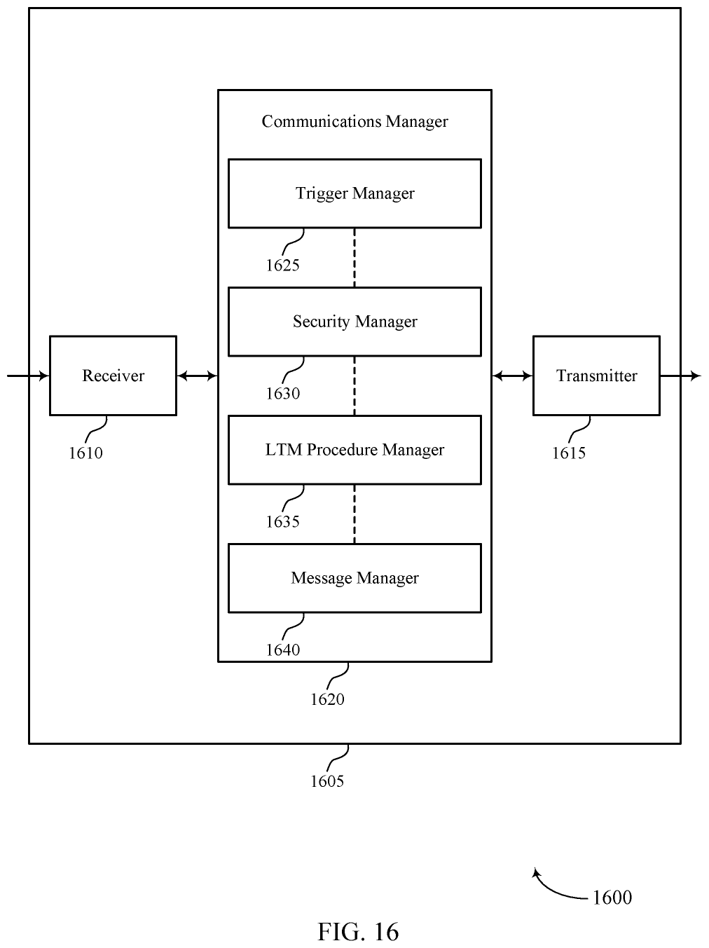

FIG. 16 shows a block diagram 1600 of a device 1605 that supports security aspects for LTM in accordance with one or more aspects of the present disclosure. The device 1605 may be an example of aspects of a device 1505 or a target network entity as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The device 1605, or various components thereof, may be an example of means for performing various aspects of security aspects for LTM as described herein. For example, the communications manager 1620 may include a trigger manager 1625, a security manager 1630, an LTM procedure manager 1635, a message manager 1640, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The trigger manager 1625 is capable of, configured to, or operable to support a means for obtaining, from a source network entity, an indication of triggering a first LTM procedure for a handover (e.g., first handover, second handover, or another handover) of a UE to a target cell provided by the target network entity, where the target cell is associated with at least one LTM candidate configuration for a second handover with an independently updated security configuration subsequent to a first handover that is based on the at least one LTM candidate configuration. The security manager 1630 is capable of, configured to, or operable to support a means for obtaining an indication of a first security configuration for securing UE communication with the target network entity. The LTM procedure manager 1635 is capable of, configured to, or operable to support a means for obtaining a message from the UE indicating a completion of the LTM procedure to the target cell. The message manager 1640 is capable of, configured to, or operable to support a means for communicating with the UE based on the message and the indication.

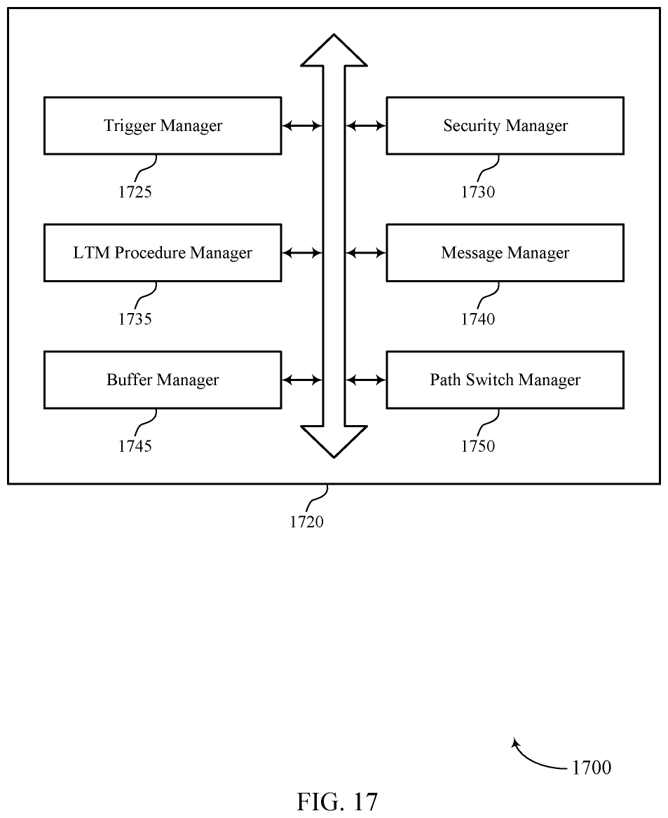

FIG. 17 shows a block diagram 1700 of a communications manager 1720 that supports security aspects for LTM in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of security aspects for LTM as described herein. For example, the communications manager 1720 may include a trigger manager 1725, a security manager 1730, an LTM procedure manager 1735, a message manager 1740, a buffer manager 1745, a path switch manager 1750, or any combination thereof. Each of these components, or components or subcomponents thereof (e.g., one or more processors, one or more memories), may communicate, directly or indirectly, with one another (e.g., via one or more buses).

The trigger manager 1725 is capable of, configured to, or operable to support a means for obtaining, from a source network entity, an indication of triggering a first LTM procedure for a handover (e.g., first handover, second handover, or another handover) of a UE to a target cell provided by the target network entity, where the target cell is associated with at least one LTM candidate configuration for a second handover with an independently updated security configuration subsequent to a first handover that is based on the at least one LTM candidate configuration. The security manager 1730 is capable of, configured to, or operable to support a means for obtaining an indication of a first security configuration for securing UE communication with the target network entity. The LTM procedure manager 1735 is capable of, configured to, or operable to support a means for obtaining a message from the UE indicating a completion of the LTM procedure to the target cell. The message manager 1740 is capable of, configured to, or operable to support a means for communicating with the UE based on the message and the indication.

In some examples, the first security configuration includes a NH value and a NCC value.

In some examples, the message includes an RRC reconfiguration complete message.

In some examples, the buffer manager 1745 is capable of, configured to, or operable to support a means for buffering the message to process the message subsequent to obtaining the indication of the first security configuration.

In some examples, the path switch manager 1750 is capable of, configured to, or operable to support a means for outputting a path switch request to an AMF entity based on the message. In some examples, the path switch manager 1750 is capable of, configured to, or operable to support a means for obtaining an acknowledgment of the path switch request with an updated NH value and an updated NCC value.

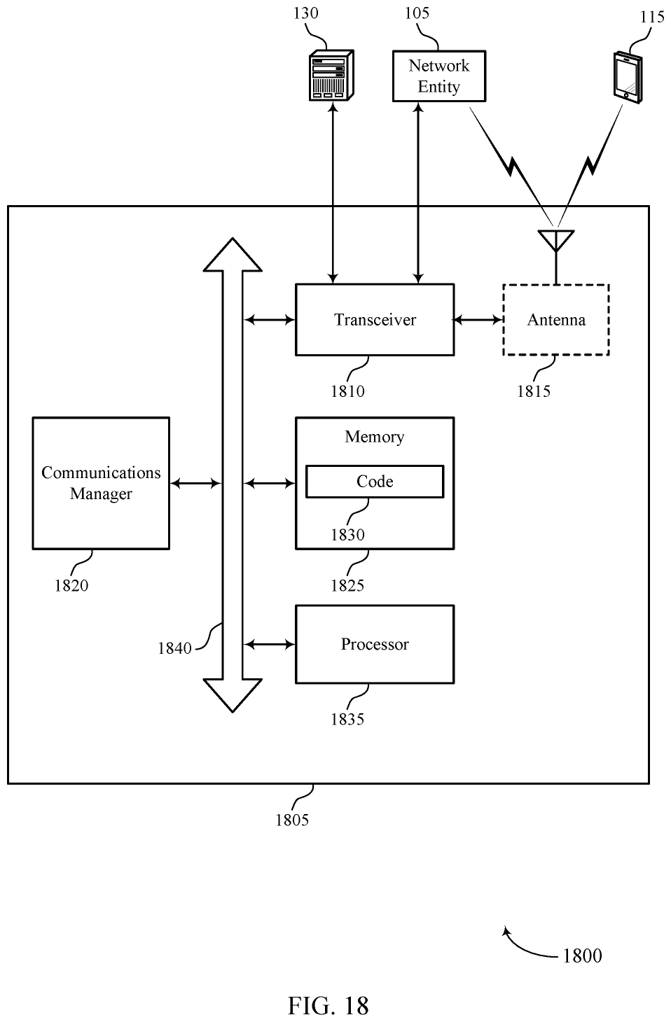

FIG. 18 shows a diagram of a system 1800 including a device 1805 that supports security aspects for LTM in accordance with one or more aspects of the present disclosure. The device 1805 may be an example of or include components of a device 1505, a device 1605, or a target network entity as described herein. The device 1805 may include components for bi-directional voice and data communications including components for transmitting and receiving communications, such as a communications manager 1820, a transceiver 1810, one or more antennas 1815, at least one memory 1825, code 1830, and at least one processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. In some implementations, the transceiver 1810 may include one or more interfaces, such as one or more interfaces coupled with the one or more antennas 1815 that are configured to support various receiving or obtaining operations, or one or more interfaces coupled with the one or more antennas 1815 that are configured to support various transmitting or outputting operations, or a combination thereof. In some implementations, the transceiver 1810 may include or be configured for coupling with one or more processors or one or more memory components that are operable to perform or support operations based on received or obtained information or signals, or to generate information or other signals for transmission or other outputting, or any combination thereof. In some implementations, the transceiver 1810, or the transceiver 1810 and the one or more antennas 1815, or the transceiver 1810 and the one or more antennas 1815 and one or more processors or one or more memory components (e.g., the at least one processor 1835, the at least one memory 1825, or both), may be included in a chip or chip assembly that is installed in the device 1805. In some examples, the transceiver 1810 may be operable to support communications via one or more communications links (e.g., communication link(s) 125, backhaul communication link(s) 120, a midhaul communication link 162, a fronthaul communication link 168).

The at least one memory 1825 may include RAM, ROM, or any combination thereof. The at least one memory 1825 may store computer-readable, computer-executable, or processor-executable code, such as the code 1830. The code 1830 may include instructions that, when executed by one or more of the at least one processor 1835, cause the device 1805 to perform various functions described herein. The code 1830 may be stored in a non-transitory computer-readable medium such as system memory or another type of memory. In some cases, the code 1830 may not be directly executable by a processor of the at least one processor 1835 but may cause a computer (e.g., when compiled and executed) to perform functions described herein. In some cases, the at least one memory 1825 may include, among other things, a BIOS which may control basic hardware or software operation such as the interaction with peripheral components or devices. In some examples, the at least one processor 1835 may include multiple processors and the at least one memory 1825 may include multiple memories. One or more of the multiple processors may be coupled with one or more of the multiple memories which may, individually or collectively, be configured to perform various functions herein (for example, as part of a processing system).

The at least one processor 1835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1835 may be configured to operate a memory array using a memory controller. In some other cases, a memory controller may be integrated into one or more of the at least one processor 1835. The at least one processor 1835 may be configured to execute computer-readable instructions stored in a memory (e.g., one or more of the at least one memory 1825) to cause the device 1805 to perform various functions (e.g., functions or tasks supporting security aspects for LTM). For example, the device 1805 or a component of the device 1805 may include at least one processor 1835 and at least one memory 1825 coupled with one or more of the at least one processor 1835, the at least one processor 1835 and the at least one memory 1825 configured to perform various functions described herein. The at least one processor 1835 may be an example of a cloud-computing platform (e.g., one or more physical nodes and supporting software such as operating systems, virtual machines, or container instances) that may host the functions (e.g., by executing code 1830) to perform the functions of the device 1805. The at least one processor 1835 may be any one or more suitable processors capable of executing scripts or instructions of one or more software programs stored in the device 1805 (such as within one or more of the at least one memory 1825). In some examples, the at least one processor 1835 may include multiple processors and the at least one memory 1825 may include multiple memories. One or more of the multiple processors may be coupled with one or more of the multiple memories, which may, individually or collectively, be configured to perform various functions herein. In some examples, the at least one processor 1835 may be a component of a processing system, which may refer to a system (such as a series) of machines, circuitry (including, for example, one or both of processor circuitry (which may include the at least one processor 1835) and memory circuitry (which may include the at least one memory 1825)), or components, that receives or obtains inputs and processes the inputs to produce, generate, or obtain a set of outputs. The processing system may be configured to perform one or more of the functions described herein. For example, the at least one processor 1835 or a processing system including the at least one processor 1835 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code stored in the at least one memory 1825 or otherwise, to perform one or more of the functions described herein.

In some examples, a bus 1840 may support communications of (e.g., within) a protocol layer of a protocol stack. In some examples, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the at least one memory 1825, the code 1830, and the at least one processor 1835 may be located in one of the different components or divided between different components).

In some examples, the communications manager 1820 may manage aspects of communications with a core network 130 (e.g., via one or more wired or wireless backhaul communication links). For example, the communications manager 1820 may manage the transfer of data communications for client devices, such as one or more UEs 115. In some examples, the communications manager 1820 may manage communications with one or more other network entities 105, and may include a controller or scheduler for controlling communications with UEs 115 (e.g., in cooperation with the one or more other network devices). In some examples, the communications manager 1820 may support an X2 interface within an LTE/LTE-A wireless communications network technology to provide communication between network entities 105.

For example, the communications manager 1820 is capable of, configured to, or operable to support a means for obtaining, from a source network entity, an indication of triggering a first LTM procedure for a handover (e.g., first handover, second handover, or another handover) of a UE to a target cell provided by the target network entity, where the target cell is associated with at least one LTM candidate configuration for a second handover with an independently updated security configuration subsequent to a first handover that is based on the at least one LTM candidate configuration. The communications manager 1820 is capable of, configured to, or operable to support a means for obtaining an indication of a first security configuration for securing UE communication with the target network entity. The communications manager 1820 is capable of, configured to, or operable to support a means for obtaining a message from the UE indicating a completion of the LTM procedure to the target cell. The communications manager 1820 is capable of, configured to, or operable to support a means for communicating with the UE based on the message and the indication.

By including or configuring the communications manager 1820 in accordance with examples as described herein, the device 1805 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some examples, one or more functions described with reference to the communications manager 1820 may be supported by or performed by the transceiver 1810, one or more of the at least one processor 1835, one or more of the at least one memory 1825, the code 1830, or any combination thereof (for example, by a processing system including at least a portion of the at least one processor 1835, the at least one memory 1825, the code 1830, or any combination thereof). For example, the code 1830 may include instructions executable by one or more of the at least one processor 1835 to cause the device 1805 to perform various aspects of security aspects for LTM as described herein, or the at least one processor 1835 and the at least one memory 1825 may be otherwise configured to, individually or collectively, perform or support such operations.

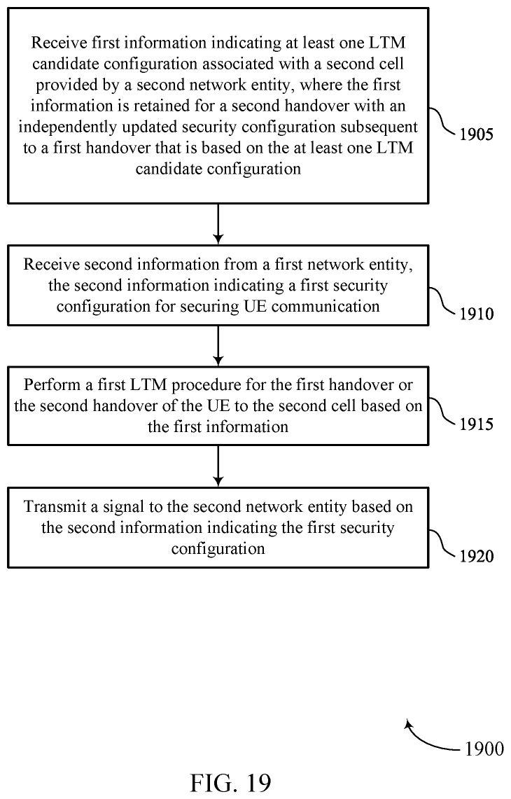

FIG. 19 shows a flowchart illustrating a method 1900 that supports security aspects for LTM in accordance with one or more aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1905, the method may include receiving first information indicating at least one LTM candidate configuration associated with a second cell provided by a second network entity, where the first information is retained for a second handover with an independently updated security configuration subsequent to a first handover that is based on the at least one LTM candidate configuration. The operations of 1905 may be performed in accordance with examples as disclosed herein. In some examples, aspects of the operations of 1905 may be performed by a candidate configuration component 925 as described with reference to FIG. 9.

At 1910, the method may include receiving second information from a first network entity, the second information indicating a first security configuration for securing UE communication. The operations of 1910 may be performed in accordance with examples as disclosed herein. In some examples, aspects of the operations of 1910 may be performed by a security configuration component 930 as described with reference to FIG. 9.

At 1915, the method may include performing a first LTM procedure for a handover (e.g., first handover, second handover, or another handover) of the UE to the second cell based on the first information. The operations of 1915 may be performed in accordance with examples as disclosed herein. In some examples, aspects of the operations of 1915 may be performed by an LTM procedure component 935 as described with reference to FIG. 9.

At 1920, the method may include transmitting a signal to the second network entity based on the second information indicating the first security configuration. The operations of 1920 may be performed in accordance with examples as disclosed herein. In some examples, aspects of the operations of 1920 may be performed by a signal component 940 as described with reference to FIG. 9.

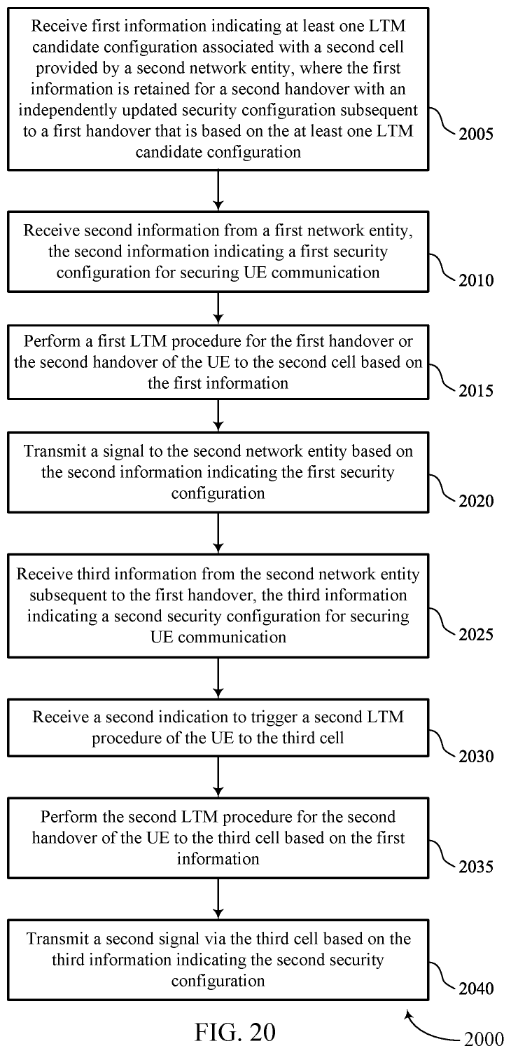

FIG. 20 shows a flowchart illustrating a method 2000 that supports security aspects for LTM in accordance with one or more aspects of the present disclosure. The operations of the method 2000 may be implemented by a UE or its components as described herein. For example, the operations of the method 2000 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2005, the method may include receiving first information indicating at least one LTM candidate configuration associated with a second cell provided by a second network entity, where the first information is retained for a second handover with an independently updated security configuration subsequent to a first handover that is based on the at least one LTM candidate configuration. The operations of 2005 may be performed in accordance with examples as disclosed herein. In some examples, aspects of the operations of 2005 may be performed by a candidate configuration component 925 as described with reference to FIG. 9.

At 2010, the method may include receiving second information from a first network entity, the second information indicating a first security configuration for securing UE communication. The operations of 2010 may be performed in accordance with examples as disclosed herein. In some examples, aspects of the operations of 2010 may be performed by a security configuration component 930 as described with reference to FIG. 9.

At 2015, the method may include performing a first LTM procedure for a handover (e.g., first handover, second handover, or another handover) of the UE to the second cell based on the first information. The operations of 2015 may be performed in accordance with examples as disclosed herein. In some examples, aspects of the operations of 2015 may be performed by an LTM procedure component 935 as described with reference to FIG. 9.

At 2020, the method may include transmitting a signal to the second network entity based on the second information indicating the first security configuration. The operations of 2020 may be performed in accordance with examples as disclosed herein. In some examples, aspects of the operations of 2020 may be performed by a signal component 940 as described with reference to FIG. 9.

At 2025, the method may include receiving third information from the second network entity subsequent to the first handover, the third information indicating a second security configuration for securing UE communication. The operations of 2025 may be performed in accordance with examples as disclosed herein. In some examples, aspects of the operations of 2025 may be performed by a security configuration component 930 as described with reference to FIG. 9.

At 2030, the method may include receiving a second indication to trigger a second LTM procedure of the UE to the third cell. The operations of 2030 may be performed in accordance with examples as disclosed herein. In some examples, aspects of the operations of 2030 may be performed by a trigger component 945 as described with reference to FIG. 9.

At 2035, the method may include performing the second LTM procedure for the second handover of the UE to the third cell based on the first information. The operations of 2035 may be performed in accordance with examples as disclosed herein. In some examples, aspects of the operations of 2035 may be performed by an LTM procedure component 935 as described with reference to FIG. 9.

At 2040, the method may include transmitting a second signal via the third cell based on the third information indicating the second security configuration. The operations of 2040 may be performed in accordance with examples as disclosed herein. In some examples, aspects of the operations of 2040 may be performed by a signal component 940 as described with reference to FIG. 9.

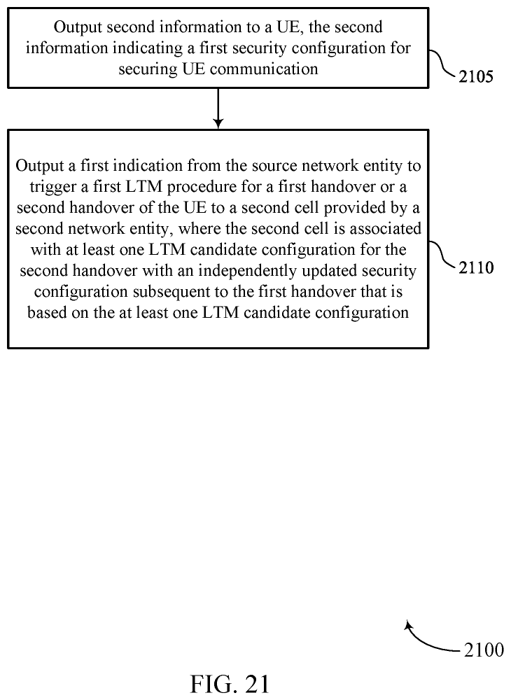

FIG. 21 shows a flowchart illustrating a method 2100 that supports security aspects for LTM in accordance with one or more aspects of the present disclosure. The operations of the method 2100 may be implemented by a source network entity or its components as described herein. For example, the operations of the method 2100 may be performed by a source network entity as described with reference to FIGS. 1 through 6 and 11 through 14. In some examples, a source network entity may execute a set of instructions to control the functional elements of the source network entity to perform the described functions. Additionally, or alternatively, the source network entity may perform aspects of the described functions using special-purpose hardware.

At 2105, the method may include outputting second information to a UE, the second information indicating a first security configuration for securing UE communication. The operations of 2105 may be performed in accordance with examples as disclosed herein. In some examples, aspects of the operations of 2105 may be performed by a security manager 1325 as described with reference to FIG. 13.

At 2110, the method may include outputting a first indication from the source network entity to trigger a first LTM procedure for a handover (e.g., first handover, second handover, or another handover) of the UE to a second cell provided by a second network entity, where the second cell is associated with at least one LTM candidate configuration for a second handover with an independently updated security configuration subsequent to a first handover that is based on the at least one LTM candidate configuration. The operations of 2110 may be performed in accordance with examples as disclosed herein. In some examples, aspects of the operations of 2110 may be performed by an LTM procedure manager 1330 as described with reference to FIG. 13.

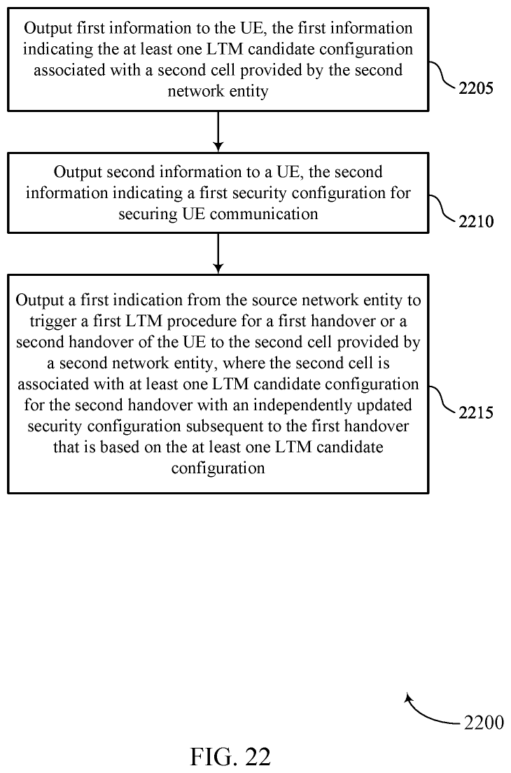

FIG. 22 shows a flowchart illustrating a method 2200 that supports security aspects for LTM in accordance with one or more aspects of the present disclosure. The operations of the method 2200 may be implemented by a source network entity or its components as described herein. For example, the operations of the method 2200 may be performed by a source network entity as described with reference to FIGS. 1 through 6 and 11 through 14. In some examples, a source network entity may execute a set of instructions to control the functional elements of the source network entity to perform the described functions. Additionally, or alternatively, the source network entity may perform aspects of the described functions using special-purpose hardware.

At 2205, the method may include outputting first information to the UE, the first information indicating the at least one LTM candidate configuration associated with a second cell provided by the second network entity. The operations of 2205 may be performed in accordance with examples as disclosed herein. In some examples, aspects of the operations of 2205 may be performed by a candidate configuration manager 1335 as described with reference to FIG. 13.

At 2210, the method may include outputting second information to a UE, the second information indicating a first security configuration for securing UE communication. The operations of 2210 may be performed in accordance with examples as disclosed herein. In some examples, aspects of the operations of 2210 may be performed by a security manager 1325 as described with reference to FIG. 13.

At 2215, the method may include outputting a first indication from the source network entity to trigger a first LTM procedure for a handover (e.g., first handover, second handover, or another handover) of the UE to the second cell provided by a second network entity, where the second cell is associated with at least one LTM candidate configuration for a second handover with an independently updated security configuration subsequent to a first handover that is based on the at least one LTM candidate configuration. The operations of 2215 may be performed in accordance with examples as disclosed herein. In some examples, aspects of the operations of 2215 may be performed by an LTM procedure manager 1330 as described with reference to FIG. 13.

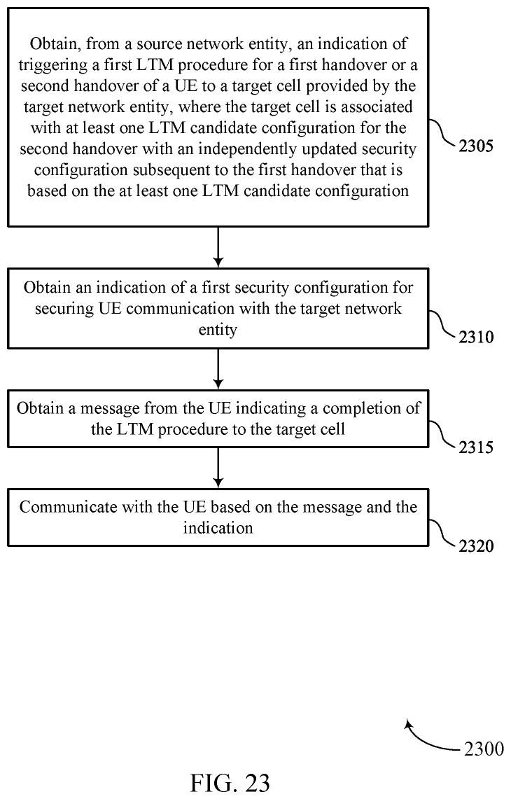

FIG. 23 shows a flowchart illustrating a method 2300 that supports security aspects for LTM in accordance with one or more aspects of the present disclosure. The operations of the method 2300 may be implemented by a target network entity or its components as described herein. For example, the operations of the method 2300 may be performed by a target network entity as described with reference to FIGS. 1 through 6 and 15 through 18. In some examples, a target network entity may execute a set of instructions to control the functional elements of the target network entity to perform the described functions. Additionally, or alternatively, the target network entity may perform aspects of the described functions using special-purpose hardware.

At 2305, the method may include obtaining, from a source network entity, an indication of triggering a first LTM procedure for a handover (e.g., first handover, second handover, or another handover) of a UE to a target cell provided by the target network entity, where the target cell is associated with at least one LTM candidate configuration for a second handover with an independently updated security configuration subsequent to a first handover that is based on the at least one LTM candidate configuration. The operations of 2305 may be performed in accordance with examples as disclosed herein. In some examples, aspects of the operations of 2305 may be performed by a trigger manager 1725 as described with reference to FIG. 17.

At 2310, the method may include obtaining an indication of a first security configuration for securing UE communication with the target network entity. The operations of 2310 may be performed in accordance with examples as disclosed herein. In some examples, aspects of the operations of 2310 may be performed by a security manager 1730 as described with reference to FIG. 17.

At 2315, the method may include obtaining a message from the UE indicating a completion of the LTM procedure to the target cell. The operations of 2315 may be performed in accordance with examples as disclosed herein. In some examples, aspects of the operations of 2315 may be performed by an LTM procedure manager 1735 as described with reference to FIG. 17.

At 2320, the method may include communicating with the UE based on the message and the indication. The operations of 2320 may be performed in accordance with examples as disclosed herein. In some examples, aspects of the operations of 2320 may be performed by a message manager 1740 as described with reference to FIG. 17.

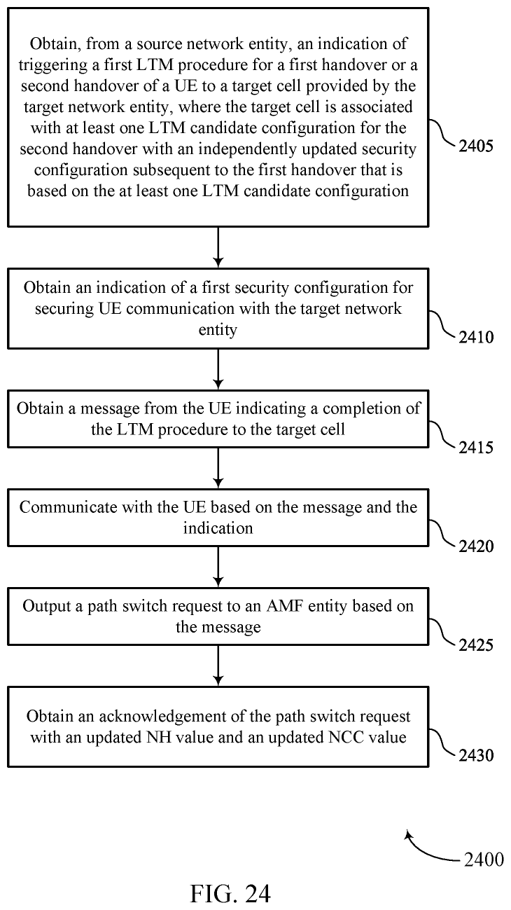

FIG. 24 shows a flowchart illustrating a method 2400 that supports security aspects for LTM in accordance with one or more aspects of the present disclosure. The operations of the method 2400 may be implemented by a target network entity or its components as described herein. For example, the operations of the method 2400 may be performed by a target network entity as described with reference to FIGS. 1 through 6 and 15 through 18. In some examples, a target network entity may execute a set of instructions to control the functional elements of the target network entity to perform the described functions. Additionally, or alternatively, the target network entity may perform aspects of the described functions using special-purpose hardware.

At 2405, the method may include obtaining, from a source network entity, an indication of triggering a first LTM procedure for a handover (e.g., first handover, second handover, or another handover) of a UE to a target cell provided by the target network entity, where the target cell is associated with at least one LTM candidate configuration for a second handover with an independently updated security configuration subsequent to a first handover that is based on the at least one LTM candidate configuration. The operations of 2405 may be performed in accordance with examples as disclosed herein. In some examples, aspects of the operations of 2405 may be performed by a trigger manager 1725 as described with reference to FIG. 17.

At 2410, the method may include obtaining an indication of a first security configuration for securing UE communication with the target network entity. The operations of 2410 may be performed in accordance with examples as disclosed herein. In some examples, aspects of the operations of 2410 may be performed by a security manager 1730 as described with reference to FIG. 17.

At 2415, the method may include obtaining a message from the UE indicating a completion of the LTM procedure to the target cell. The operations of 2415 may be performed in accordance with examples as disclosed herein. In some examples, aspects of the operations of 2415 may be performed by an LTM procedure manager 1735 as described with reference to FIG. 17.

At 2420, the method may include communicating with the UE based on the message and the indication. The operations of 2420 may be performed in accordance with examples as disclosed herein. In some examples, aspects of the operations of 2420 may be performed by a message manager 1740 as described with reference to FIG. 17.

At 2425, the method may include outputting a path switch request to an AMF entity based on the message. The operations of 2425 may be performed in accordance with examples as disclosed herein. In some examples, aspects of the operations of 2425 may be performed by a path switch manager 1750 as described with reference to FIG. 17.

At 2430, the method may include obtaining an acknowledgment of the path switch request with an updated NH value and an updated NCC value. The operations of 2430 may be performed in accordance with examples as disclosed herein. In some examples, aspects of the operations of 2430 may be performed by a path switch manager 1750 as described with reference to FIG. 17.

The following provides an overview of aspects of the present disclosure:

Aspect 1: A method for wireless communication at a UE, comprising: receiving first information indicating at least one LTM candidate configuration associated with a second cell provided by a second network entity, wherein the first information is retained for a second handover with an independently updated security configuration subsequent to a first handover that is based on the at least one LTM candidate configuration; receiving second information from a first network entity, the second information indicating a first security configuration for securing UE communication; performing a first LTM procedure for a handover (e.g., first handover, second handover, or another handover) of the UE to the second cell based at least in part on the first information; and transmitting a signal to the second network entity based at least in part on the second information indicating the first security configuration.

Aspect 2: The method of aspect 1, wherein the first information indicating the at least one LTM candidate configuration and the second information indicating the first security configuration are received in a same message.

Aspect 3: The method of any of aspects 1 through 2, wherein the first information indicating the at least one LTM candidate configuration comprises an LTM candidate configuration associated with a third cell and the first LTM procedure is for the first handover, the method further comprising: receiving third information from the second network entity subsequent to the first handover, the third information indicating a second security configuration for securing UE communication; receiving a second indication to trigger a second LTM procedure of the UE to the third cell; performing the second LTM procedure for the second handover of the UE to the third cell based at least in part on the first information; and transmitting a second signal via the third cell based at least in part on the third information indicating the second security configuration.

Aspect 4: The method of aspect 1, wherein the first information indicating the at least one LTM candidate configuration and the second information indicating the first security configuration are received from different network entities.

Aspect 5: The method of aspect 4, the method further comprising performing a second LTM procedure for the first handover of the UE to a first cell provided by the first network entity prior to receiving the second information.

Aspect 6: The method of any of aspects 1 through 5, wherein the first security configuration comprises a NCC value.

Aspect 7: The method of any of aspects 1 through 6, wherein the second information comprises an indication that the first security configuration is for an LTM procedure between network entities, an LTM procedure to the second network entity, an LTM procedure to a network entity included in a set of network entities comprising the second network entity, an LTM procedure to a first cell provided by the first network entity, an LTM procedure to a cell included in a set of cells comprising a first cell provided by the first network entity, or any combination thereof.

Aspect 8: The method of any of aspects 1 through 2, wherein the first information and the second information are received from one network entity.

Aspect 9: A method for wireless communications at a source network entity, comprising: outputting second information to a UE, the second information indicating a first security configuration for securing UE communication; and outputting a first indication from the source network entity to trigger a first LTM procedure for a handover (e.g., first handover, second handover, or another handover) of the UE to a second cell provided by a second network entity, wherein the second cell is associated with at least one LTM candidate configuration for a second handover with an independently updated security configuration subsequent to a first handover that is based on the at least one LTM candidate configuration.

Aspect 10: The method of aspect 9, wherein the first security configuration comprises a NCC value.

Aspect 11: The method of any of aspects 9 through 10, wherein the second information comprises an indication that the first security configuration is for an LTM procedure between network entities, an LTM procedure to the second network entity, an LTM procedure to a network entity included in a set of network entities comprising the second network entity, an LTM procedure to a first cell provided by the source network entity, an LTM procedure to a cell included in a set of cells comprising a first cell provided by the source network entity, or any combination thereof.

Aspect 12: The method of any of aspects 9 through 11, further comprising: outputting first information to the UE, the first information indicating the at least one LTM candidate configuration associated with the second cell provided by the second network entity.

Aspect 13: The method of any of aspects 9 through 12, further comprising: outputting an indication of the first security configuration to a network entity that provides a cell that is associated with the at least one LTM candidate configuration for the UE.

Aspect 14: The method of aspect 13, wherein the network entity is the second network entity and the cell is a target cell for the first LTM procedure for the first handover.

Aspect 15: The method of aspect 13, wherein the network entity is a third network entity separate from the second network entity and the cell is a third cell separate from a target cell for the first LTM procedure for the first handover.

Aspect 16: The method of any of aspects 13 through 15, wherein the indication further indicates a NCC value and a key value associated with the cell provided by the network entity.

Aspect 17: The method of any of aspects 13 through 16, wherein the indication is outputted concurrently with the first LTM procedure or subsequent to the first LTM procedure.

Aspect 18: The method of any of aspects 13 through 16, wherein the indication is outputted prior to the first LTM procedure or prior to outputting the second information to the UE.

Aspect 19: The method of any of aspects 13 through 18, further comprising: outputting a second indication to the network entity to invalidate the indication of the first security configuration based at least in part on a performance of an LTM procedure of the UE to a target cell separate from the cell that is associated with the at least one LTM candidate configuration for the UE.

Aspect 20: The method of any of aspects 9 through 19, further comprising: obtaining at least part of the first security configuration from an AMF entity associated with the UE for outputting the second information to the UE, the first security configuration comprising a NCC value or an indication for the source network entity to utilize a fresh key.

Aspect 21: The method of aspect 20, further comprising: outputting an NCC value of zero to the UE in response to the indication for the source network entity to utilize the fresh key.

Aspect 22: The method of any of aspects 9 through 21, wherein the source network entity comprises a CU and a DU, wherein: the CU outputs the second information to the UE via the DU, the DU outputs the first indication to trigger the first LTM procedure to the UE, the DU outputs an indication of triggering the first LTM procedure to the CU, and the CU outputs an indication of the first security configuration to the second network entity, a third network entity, or a combination thereof.

Aspect 23: The method of any of aspects 9 through 13 and 15, wherein the second network entity is the source network entity.

Aspect 24: A method for wireless communications at a target network entity, comprising: obtaining, from a source network entity, an indication of triggering a first LTM procedure for a handover (e.g., first handover, second handover, or another handover) of a UE to a target cell provided by the target network entity, wherein the target cell is associated with at least one LTM candidate configuration for a second handover with an independently updated security configuration subsequent to a first handover that is based on the at least one LTM candidate configuration; obtaining an indication of a first security configuration for securing UE communication with the target network entity; obtaining a message from the UE indicating a completion of the LTM procedure to the target cell; and communicating with the UE based at least in part on the message and the indication.

Aspect 25: The method of aspect 24, wherein the first security configuration comprises a NH value and a NCC value.

Aspect 26: The method of any of aspects 24 through 25, wherein the message comprises an RRC reconfiguration complete message.

Aspect 27: The method of any of aspects 24 through 26, wherein the target network entity obtains the message prior to obtaining the indication of the first security configuration, the method further comprising: buffering the message to process the message subsequent to obtaining the indication of the first security configuration.

Aspect 28: The method of any of aspects 24 through 27, further comprising: outputting a path switch request to an AMF entity based at least in part on the message; and obtaining an acknowledgment of the path switch request with an updated NH value and an updated NCC value.

Aspect 29: A UE comprising one or more memories storing processor-executable code, and one or more processors coupled with the one or more memories and individually or collectively operable to execute the code to cause the UE to perform a method of any of aspects 1 through 8.

Aspect 30: A UE comprising at least one means for performing a method of any of aspects 1 through 8.

Aspect 31: A non-transitory computer-readable medium storing code the code comprising instructions executable by one or more processors to perform a method of any of aspects 1 through 8.

Aspect 32: A source network entity comprising one or more memories storing processor-executable code, and one or more processors coupled with the one or more memories and individually or collectively operable to execute the code to cause the source network entity to perform a method of any of aspects 9 through 23.

Aspect 33: A source network entity comprising at least one means for performing a method of any of aspects 9 through 23.

Aspect 34: A non-transitory computer-readable medium storing code the code comprising instructions executable by one or more processors to perform a method of any of aspects 9 through 23.

Aspect 35: A target network entity comprising one or more memories storing processor-executable code, and one or more processors coupled with the one or more memories and individually or collectively operable to execute the code to cause the target network entity to perform a method of any of aspects 24 through 28.

Aspect 36: A target network entity comprising at least one means for performing a method of any of aspects 24 through 28.

Aspect 37: A non-transitory computer-readable medium storing code the code comprising instructions executable by one or more processors to perform a method of any of aspects 24 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first information indicating at least one layer 1 or layer 2 triggered mobility (LTM) candidate configuration associated with a second cell provided by a second network entity, wherein the first information is retained for a second handover with an independently updated security configuration subsequent to a first handover that is based on the at least one LTM candidate configuration;
receive second information from a first network entity, the second information indicating a first security configuration for securing UE communication;
perform a first LTM procedure for the first handover or the second handover of the UE to the second cell based at least in part on the first information; and
transmit a signal to the second network entity based at least in part on the second information indicating the first security configuration.

2. The UE of claim 1, wherein the first information indicating the at least one LTM candidate configuration and the second information indicating the first security configuration are received in a same message.

3. The UE of claim 1, wherein the first information indicating the at least one LTM candidate configuration comprises an LTM candidate configuration associated with a third cell and the first LTM procedure is for the first handover, wherein the one or more processors are individually or collectively operable to execute the code to cause the UE to:
receive third information from the second network entity subsequent to the first handover, the third information indicating a second security configuration for securing UE communication;
receive a second indication to trigger a second LTM procedure of the UE to the third cell;
perform the second LTM procedure for the second handover of the UE to the third cell based at least in part on the first information; and
transmit a second signal via the third cell based at least in part on the third information indicating the second security configuration.

4. The UE of claim 1, wherein the first information indicating the at least one LTM candidate configuration and the second information indicating the first security configuration are received from different network entities.

5. The UE of claim 4, wherein the one or more processors are individually or collectively operable to execute the code to cause the UE to perform a second LTM procedure for the first handover of the UE to a first cell provided by the first network entity prior to receiving the second information.

6. The UE of claim 1, wherein the first security configuration comprises a next hop chaining count (NCC) value.

7. The UE of claim 1, wherein the second information comprises an indication that the first security configuration is for an LTM procedure between network entities, an LTM procedure to the second network entity, an LTM procedure to a network entity included in a set of network entities comprising the second network entity, an LTM procedure to a first cell provided by the first network entity, an LTM procedure to a cell included in a set of cells comprising a first cell provided by the first network entity, or any combination thereof.

8. The UE of claim 1, wherein:
the first information and the second information are received from one network entity.

9. A source network entity, comprising:
one or more memories storing processor-executable code; and
one or more processors coupled with the one or more memories and individually or collectively operable to execute the code to cause the source network entity to:
output second information to a user equipment (UE), the second information indicating a first security configuration for securing UE communication; and
output a first indication from the source network entity to trigger a first layer 1 or layer 2 triggered mobility (LTM) procedure for a first handover or a second handover of the UE to a second cell provided by a second network entity, wherein the second cell is associated with at least one LTM candidate configuration for the second handover with an independently updated security configuration subsequent to the first handover that is based on the at least one LTM candidate configuration.

10. The source network entity of claim 9, wherein the first security configuration comprises a next hop chaining count (NCC) value.

11. The source network entity of claim 9, wherein the second information comprises an indication that the first security configuration is for an LTM procedure between network entities, an LTM procedure to the second network entity, an LTM procedure to a network entity included in a set of network entities comprising the second network entity, an LTM procedure to a first cell provided by the source network entity, an LTM procedure to a cell included in a set of cells comprising a first cell provided by the source network entity, or any combination thereof.

12. The source network entity of claim 9, wherein the one or more processors are individually or collectively further operable to execute the code to cause the source network entity to:
output first information to the UE, the first information indicating the at least one LTM candidate configuration associated with the second cell provided by the second network entity.

13. The source network entity of claim 9, wherein the one or more processors are individually or collectively further operable to execute the code to cause the source network entity to:
output an indication of the first security configuration to a network entity that provides a cell that is associated with the at least one LTM candidate configuration for the UE.

14. The source network entity of claim 13, wherein the network entity is the second network entity and the cell is a target cell for the first LTM procedure for the first handover.

15. The source network entity of claim 13, wherein the network entity is a third network entity separate from the second network entity and the cell is a third cell separate from a target cell for the first LTM procedure for the first handover.

16. The source network entity of claim 13, wherein the indication further indicates a next hop chaining count (NCC) value and a key value associated with the cell provided by the network entity.

17. The source network entity of claim 13, wherein the indication is outputted concurrently with the first LTM procedure or subsequent to the first LTM procedure.

18. The source network entity of claim 13, wherein the indication is outputted prior to the first LTM procedure or prior to outputting the second information to the UE.

19. The source network entity of claim 13, wherein the one or more processors are individually or collectively further operable to execute the code to cause the source network entity to:
output a second indication to the network entity to invalidate the indication of the first security configuration based at least in part on a performance of an LTM procedure of the UE to a target cell separate from the cell that is associated with the at least one LTM candidate configuration for the UE.

20. The source network entity of claim 9, wherein the one or more processors are individually or collectively further operable to execute the code to cause the source network entity to:
obtain at least part of the first security configuration from an access and mobility management function (AMF) entity associated with the UE for outputting the second information to the UE, the first security configuration comprising a next hop chaining count (NCC) value or an indication for the source network entity to utilize a fresh key.

21. The source network entity of claim 20, wherein the one or more processors are individually or collectively further operable to execute the code to cause the source network entity to:
output an NCC value of zero to the UE in response to the indication for the source network entity to utilize the fresh key.

22. The source network entity of claim 9, wherein the source network entity comprises a central unit (CU) and a distributed unit (DU), and wherein:
the CU outputs the second information to the UE via the DU,
the DU outputs the first indication to trigger the first LTM procedure to the UE,
the DU outputs an indication of triggering the first LTM procedure to the CU, and
the CU outputs an indication of the first security configuration to the second network entity, a third network entity, or a combination thereof.

23. The source network entity of claim 9, wherein the second network entity is the source network entity.

24. A target network entity, comprising:
one or more memories storing processor-executable code; and
one or more processors coupled with the one or more memories and individually or collectively operable to execute the code to cause the target network entity to:
obtain, from a source network entity, an indication of triggering a first layer 1 or layer 2 triggered mobility (LTM) procedure for a first handover or a second handover of a user equipment (UE) to a target cell provided by the target network entity, wherein the target cell is associated with at least one LTM candidate configuration for the second handover with an independently updated security configuration subsequent to the first handover that is based on the at least one LTM candidate configuration;
obtain an indication of a first security configuration for securing UE communication with the target network entity;
obtain a message from the UE indicating a completion of the LTM procedure to the target cell; and
communicate with the UE based at least in part on the message and the indication.

25. The target network entity of claim 24, wherein the first security configuration comprises a next hop (NH) value and a next hop chaining count (NCC) value.

26. The target network entity of claim 24, wherein the message comprises a radio resource control (RRC) reconfiguration complete message.

27. The target network entity of claim 24, wherein the one or more processors are individually or collectively further operable to execute the code to cause the target network entity to:
buffer the message to process the message subsequent to obtaining the indication of the first security configuration.

28. The target network entity of claim 24, wherein the one or more processors are individually or collectively further operable to execute the code to cause the target network entity to:
output a path switch request to an access and mobility management function (AMF) entity based at least in part on the message; and
obtain an acknowledgment of the path switch request with an updated next hop (NH) value and an updated next hop chaining count (NCC) value.

29. A method for wireless communication at a user equipment (UE), comprising:
receiving first information indicating at least one layer 1 or layer 2 triggered mobility (LTM) candidate configuration associated with a second cell provided by a second network entity, wherein the first information is retained for a second handover with an independently updated security configuration subsequent to a first handover that is based on the at least one LTM candidate configuration;
receiving second information from a first network entity, the second information indicating a first security configuration for securing UE communication;
performing a first LTM procedure for the first handover or the second handover of the UE to the second cell based at least in part on the first information; and
transmitting a signal to the second network entity based at least in part on the second information indicating the first security configuration.

30. The method of claim 29, wherein the first information indicating the at least one LTM candidate configuration and the second information indicating the first security configuration are received in a same message.
